(19) United States
(12) Patent Application Publication
(10) Pub. No.: US 2024/0178440 A1
(43) Pub. Date: May 30, 2024

(54) SOLID-STATE ELECTROLYTES

(71) Applicant: Ohio State Innovation Foundation, Columbus, OH (US)

(72) Inventors: Yiying WU, Columbus, OH (US); Jingfeng ZHENG, Columbus, OH (US)

(21) Appl. No.: 18/284,726

(22) PCT Filed: Apr. 1, 2022
(86) PCT No.: PCT/US2022/023024

§ 371 Date: Sep. 28, 2023

Related U.S. Application Data
(60) Provisional application No. 63/170,077, filed on Apr. 2, 2021.

(51) Int. Cl. H01M 10/0562; H01M 6/18

(52) U.S. Cl. CPC H01M 10/0562; H01M 6/182; H01M 2300/008

(57) ABSTRACT

Disclosed are solid-state electrolytes having high ionic conductivity and adapted for use in alkaline batteries. Batteries comprising such electrolytes are also disclosed. Also disclosed are methods of making solid-state electrolytes.

### CROSS-REFERENCE TO RELATED APPLICATIONS

This application claims the benefit of U.S. Provisional Application No. 63/170,077 filed Apr. 2, 2021, the content of which is incorporated herein by reference in its entirety.

### STATEMENT REGARDING FEDERALLY SPONSORED RESEARCH

This invention was made with government support under award number DE-FG02-07ER46427, awarded by the Department of Energy. The government has certain rights in the invention.

### TECHNICAL FIELD

This application relates generally to solid-state electrolytes, batteries comprising the same, and methods of making the same.

### BACKGROUND

Potassium batteries with organic liquid electrolytes, including K-ion, K-O₂, and K-S batteries, have been regarded as promising candidates for large-scale energy storage due to their high earth abundance and low redox potential (−2.93 V versus SHE). However, the issues brought by using liquid electrolytes still hinder the development of K-batteries. The utilization of solid electrolytes may not only have the commonly recognized benefits in suppressing dendritic metal plating and enhancing battery safety but also blocks oxygen or sulfur crossover from the cathode.

The search for K-ion solid-state electrolytes is in infancy. The commercial K-beta″ −Al₂O₃ shows the highest ionic conductivity (8×10⁻⁴ S cm⁻¹ at room temperature and 4×10⁻³ S cm⁻¹ at 100° C.) The ionic conductivity of other potassium-ion solid-state electrolytes is low (<0.1 mS cm⁻¹) at room temperature. For K-beta″ —Al₂O₃, its extremely high sintering temperature (1200-1500° C.) limits its application. Moreover, the price of the commercial K-beta″ —Al₂O₃ pellet is also too high for practical application. Therefore, new K-ion solid-state electrolytes with high ionic conductivity are desired.

Thus, new solid-state electrolytes having high ionic conductivity and adapted for use in alkaline batteries are needed. These needs and other needs are at least partially satisfied by the present disclosure.

### SUMMARY

The present disclosure is directed to a solid-state electrolyte comprising a compound having a formula A₍₃₋ₓ₎M_{y}B_{w}C_{z}, wherein x is from 0 to 1; y is x, or x/2 or x/3; w is from 0 to 1; z is from 0 to 1, and wherein A is a metal cation comprising Na⁺, Li⁺, or K⁺, M is a monovalent, a divalent or a trivalent metal cation; B comprises O²⁻ or S²⁻, and C is an anion comprising F⁻, Cl⁻, Br⁻, I⁻, CN⁻, NO₂⁻, or a combination thereof.

In still further aspects, disclosed is the solid-state electrolyte where A is K⁺ and B is O²⁻. In yet further aspects, the solid-state electrolyte disclosed herein comprises C is selected from a group consisting of F⁻, Cl⁻, Br⁻, and I⁻, or a combination thereof.

Also disclosed is the solid-state electrolyte where x is greater than 0. In such exemplary and unlimiting aspects, M is Ba²⁺. In yet other aspects, M is Rb⁺. In still further exemplary aspects, an ionic conductivity of such a compound is at least one order of magnitude is higher than an ionic conductivity of a compound A₍₃₋ₓ₎M_{y}B_{w}C_{z} having substantially identical A, B, and C with x=0.

Also disclosed herein is a battery comprising an anode, a cathode, and any of the disclosed herein solid-state electrolytes. In such exemplary aspects, the battery can be a primary battery or a secondary battery.

Also disclosed herein is a method comprising reacting a metal A with i) a salt comprising a cation A and a B, and ii) a salt comprising the cation A and an anion C at a temperature effective to form a compound having a formula A₃B_{w}C_{z}; wherein A comprises Na, Li, or K; B comprises O²⁻ or S²⁻; and C comprises F⁻, Cl⁻, Br⁻, I⁻, CN⁻, NO2⁻ or a combination thereof.

The disclosed herein methods further comprise doping the compound A₃B_{w}C_{z} to form a compound of a formula A₍₃₋ₓ₎M_{y}B_{w}C_{z}, wherein x is greater than 0 to 1; y is x, or x/2 or x/3; and wherein M is a monovalent, a divalent or a trivalent metal cation.

Additional advantages will be set forth in part in the description which follows, and in part will be obvious from the description or can be learned by practice of the aspects described below. The advantages described below will be realized and attained by means of the chemical compositions, methods, and combinations thereof, particularly pointed out in the appended claims. It is to be understood that both the foregoing general description and the following detailed description are exemplary and explanatory only and are not restrictive of the invention, as claimed.

### BRIEF DESCRIPTION OF FIGURES

The accompanying figures, which are incorporated in and constitute a part of this specification, illustrate several aspects described below.

FIGS. 1A-1B depict the following: FIG. 1A depicts a Rietveld refinement plot of K₃OI The inset shows the cubic anti-perovskite structure of the material, with O shown in the corners, K between the oxygen atoms, and I in the middle. FIG. 1B depicts a DSC measurement of K₃OI. The scan rate is 5° C./min.

FIGS. 2A-2D depict the following: FIG. 2A depicts synchrotron XRD results of K₃OI. FIG. 2B depicts the cell volume of K₃OI at different temperatures. FIG. 2C depicts a Nyquist plot of the K₃OI sample at different temperatures. Pt was sputtered on both sides of the sample pellet as a blocking electrode. FIG. 2D shows Arrhenius plots of the ionic conductivity for K₃OI. The ionic conductivity test was done by colling from high temperature to low temperature.

FIGS. 3A-3D depict the following: FIG. 3A depicts a Nyquist plot of the K_{2.9}Ba_{0.05}OI sample at different temperatures. Pt was sputtered on both sides of the sample pellet as a blocking electrode. FIG. 3B depicts an Arrhenius plot of the ionic conductivity for K₃OI and K_{2.9}Ba_{0.05}OI. The ionic conductivity test was done by cooling from a high temperature to a low temperature. FIG. 3C shows electrochemical performance of the symmetric K/K_{2.9}Ba_{0.05}OI/K cell at current density of 0.2 mA/cm² (corresponding depth of discharge: 0.1 mAh/cm²) and then 0.5 mA/cm² (corresponding depth of discharge: 0.25 mAh/cm²) at 270° C. FIG. 3D shows a Nyquist plot of the symmetric K/K_{2.9}Ba_{0.05}OI/K cell after 10 cycles. The equivalent circuit model is inserted on the top. The SEM images of the electrolyte after cycling are shown in FIG. 21.

FIGS. 4A-4C depict optimized 2×2×2 supercells used in the study of anti-perovskite K₃OI. FIG. 4A depicts a defect-free structure is depicted in a ‘stick’ style to show the interwoven sublattices of iodine ( [symbol] ) and oxygen ( [symbol] ), where potassium sites ( [symbol] ) are situated octahedrally around each oxygen site. FIG. 4B depicts an exemplary structure containing one K⁺ vacancy (shown by the hollow ball) out of a total of 24 potassium sites, corresponding to a 4% defect concentration. The ‘stick-and-ball style’ of the structure shows that the iodine atom ( [symbol] ) and the oxygen atom ( [symbol] ) are situated at the center and the vertices, respectively, of each cubic unit cell. The potassium atoms ( [symbol] ) are situated at the middle points of the unit-cell edges. FIG. 4C depicts simulated XRD spectra using the structural models compared to the measured one. Presence of the K⁺ vacancy reduces lattice parameters significantly while maintaining the cubic symmetry of the material.

FIGS. 5A-5C depicts calculated mean squared displacements of different species at simulated temperatures of 800, 1000, 1100, and 1200 K. Large displacements of oxygen and iodine appear around 40 ps at 1000, 1100, and 1200 K, indicating a phase transition of the structure. The arrow in the ‘iodine’ panel points to the large MSD of iodine equivalent to about \sqrt{14}≈ 3.7 Å displacement, triggering the phase transition. No phase transition is observed at the simulated temperature of 800 K.

FIGS. 6A-6D show results obtained from the molecular dynamics (MD) simulations based on the defect-free and vacancy-containing models. FIG. 6A depicts calculated free energy profiles at 300 (upper panel) and 600 K and show no phase transition in an exemplary structure. FIG. 6B depicts a pair distribution function (PDF) analysis for different species pairs (O-K, O-O, O-I, and I-I) at 300 (middle line) and 600 K (top line). Compared to the case of the optimized structure at 0 K (bottom line), all the PDF peaks are clearly shown except for the broadening due to thermal fluctuation at high temperatures, suggesting that there is no phase transition. FIG. 6C depicts calculated free energy at 600 K based on the vacancy-containing model. Three-phase regions (p1, p2, and p3) are observed (indicated by the lines). The PDF analysis for different pairs of species in each phase region is given in FIG. 6D, where, for comparison in each case, the sharp PDF peaks at the ‘0’ phase region corresponding to the case of a defect-free structure at 0 K.

FIGS. 7A-7C depict the relation between the K⁺-vacancy defect and the observed phase transition of the material. FIG. 7A depicts a structure snapshot containing a local iodine ( [symbol] ) and oxygen ( [symbol] ) disorder. The disordered atoms are indicated by the arrows. FIG. 7B depicts a molecular dynamics simulation at 600 K (above the phase transition temperature observed in the experiment) with constant temperature, and a constant pressure ensemble shows that the K-vacancy containing structure undergoes relaxations, as indicated by the stepwise changes p1, p2, and p3 in total energy over the simulation time up to 90 ps. FIG. 7C shows the calculated radical distribution function (RDF) of O-I corresponding to the relaxed structures in the simulation shown in FIG. 7B. For a defect-free structure and ground-state structure (at 0 K), there is no peak for the O-I distance in 3.0-4.0 Å. For the relaxed K-vacancy containing structures at 600K, however, multiple peaks appear in this short distance range, corresponding to the distances between moving iodine to the vacant K site and the neighboring oxygen, as depicted in FIG. 7A.

FIGS. 8A-8C depict the following: FIG. 8A depicts a high-temperature electrochemical Swagelok cell for AC impedance measurement in one aspect. FIG. 8B depicts a cross section of an exemplary electrochemical cell in one aspect. FIG. 8C depicts individual parts of the cell in FIGS. 8A-8B in one aspect. The insulating layer can be Kapton film or glass fiber paper.

FIG. 9 depicts an XRD spectrum of K₂O using the reaction of K and KNO₃ at 170° C.for 12 hours.

FIG. 10 depicts Raman spectra of K₂O using the reaction of K and KNO₃ at 170° C.for 12 hours.

FIG. 11 depicts Raman spectra of KOH and K₃OI. KOH shows OH vibration at 3600 cm⁻¹; K₃OI does not show any peak from 3000 cm⁻¹ to 4000 cm⁻¹. It indicates the K₃OI sample is free of the OH group.

FIG. 12 depicts XRD spectra of K₃OI before and after sintering and ionic conductivity test. The unchanged XRD results indicate the sintering process and ionic conductivity test does not change the composition of an exemplary sample.

FIG. 13 depicts Arrhenius plots of the ionic conductivity for pristine K₃OI, K₂O-rich K₃OI, and K₂O-deficient K₃OI sample.

FIG. 14 depicts calculated ionic conductivities at 800, 1000, 1100, and 1200 K and the extrapolation to other temperatures compared to the experimental values.

FIGS. 15A-15B depict Nyquist plot fittings using Zview software. The equivalent circuit is inserted. FIG. 15A shows the Nyquist plot of K_{2.9}Ba_{0.05}OI at 189° C. The Nyquist plot contains a semicircle at high frequency and a spike at low frequency. Ri represents the resistance of the solid-state electrolyte; CPE_{d} represents the geometry capacitance of the cell; CPE_{dl} is from the interface of electrolyte and Pt blocking electrodes. FIG. 15B shows the Nyquist plot of K_{2.9}Ba_{0.05}OI at 248° C. The Nyquist plot contains a spike intercepting with X-axis but no semicircle. It is due to the cutoff frequency being higher than the maximum frequency of the instrument (1 MHZ). Ri represents the resistance of the solid-state electrolyte; CPE_{dl} is from the interface of electrolyte and Pt blocking electrodes.

FIGS. 16A-16C show a calculated mean squared displacement (MSD) of K-ions at different temperatures using data from AIMD simulations. (FIG. 16A) Without the K vacancy (w/o K-vacancy), The MSD at 1000 K becomes zero, suggesting that the vacancy defect is crucial for the fast-ion diffusion of the material. The inset shows the calculated ionic conductivities from MSD at the simulation temperatures and extrapolation of these points to other temperatures by the Arrhenius relation. FIG. 16B shows a calculated probability distribution functions P(I), P(O), and P(K) for iodine, oxygen, and potassium, respectively, at the low simulation temperature (800 K, low T) and the high simulation temperature (1200 K). The model structure is superimposed on the probability distribution iso-surfaces (in yellow) to show the sites of different species. At the low temperature, only the K-ion ( [symbol] ) migration via its neighboring vacancy site is observed, as indicated by the arrows. At the high temperature, local disordering in the iodine ( [symbol] ) and oxygen ( [symbol] ) sublattice is observed, with I moving to the neighboring vacancy shown in P(I) and O moving toward the vacated I site shown in P(O), as indicated by the arrows. Consequently, as indicated by the arrows in P(K), K ions can transport through both the neighbor vacancies as well as the large space around the local I-O disorder. FIG. 16C shows calculated activation energy for the formation of a local I-O disorder in the 2×2×2 cell of a nonstoichiometric system K_{2.875}OI_{0.875}, with K ( [symbol] ), O ( [symbol] ) and I ( [symbol] ). The starting state is the lowest-energy configuration containing one Schottky pair of (KI)v. T(O-Iv) is the transition state when O (red) is moving toward the neighboring vacated I site. O(Iv) is the end state.

FIG. 17 depicts the XRD results of K₃OI and K metal after heating at 300° C. for 12 hours. Both K₃OI and K metal have a cubic lattice system. The lattice parameter for K₃OI and K metal is 5.30713(4) Å and 5.328 Å, respectively. Thus, several diffraction peaks overlapped. The XRD result clearly shows that there is no change for K₃OI and K metal.

FIGS. 18A-18C show a K_{2.9}Ba_{0.05}OI powder sample (FIG. 18A), a K_{2.9}Ba_{0.05}OI sample pellet before sintering (FIG. 18B), and a K_{2.9}Ba_{0.05}OI sample pellet after sintering (FIG. 18C).

FIGS. 19A-19F show energy dispersive X-ray Spectroscopy (EDS) of a K_{2.9}Ba_{0.05}OI powder (FIG. 19A); element mapping of K_{2.9}Ba_{0.05}OI powder, including SEM image (FIG. 19B), O element (FIG. 19C), I element (FIG. 19D), K element (FIG. 19E), and Ba element (FIG. 19F).

FIG. 20 shows the XRD results of synthesized K₃OI at the range of 10 to 80°. *Signal from the protective film on the XRD sample holder.

FIG. 21 shows a cross-section of the K/K_{2.9}Ba_{0.05}OI/K cell after cycling. The K electrode is composed of K metal and P50 carbon paper.

FIGS. 22A-22B show a Nyquist plot fitting using Zview software. The equivalent circuit is inserted. FIG. 22A shows the Nyquist plot of K₃OI at 203° C. The Nyquist plot contains a semicircle at high frequency and a spike at low frequency. Rᵢ represents the resistance of the solid-state electrolyte; CPE_{d} represents the geometry capacitance of the cell; CPE_{dl} is from the interface of electrolyte and Pt blocking electrodes. FIG. 22B shows the Nyquist plot of K₃OI at 231° C. The Nyquist plot contains a spike intercepting with the X-axis and only part of the semicircle. It is due to the cutoff frequency being higher than the maximum frequency of the instrument (1 MHZ). Rᵢ represents the resistance of the solid-state electrolyte; CPE_{dl} is from the interface of electrolyte and Pt blocking electrodes.

FIG. 23 shows a bottleneck comparison of K₃OCl, K₃OBr, and K₃OI.

FIGS. 24A-24B show a migration map of cubic phase K₃OX. (FIG. 24A) The dark spheres represent the lowest energy point. The Br1 spheres represent the saddle point. The different types of spheres show different energy iso-surface. (FIG. 24B) Migration map with bottleneck shown. The triangle composed of one oxygen and two halogens is the bottleneck for two highlighted K-ions.

FIGS. 25A-25C show a comparison of migration barriers along the reaction pathway for K-ions in K₃OX.

FIG. 26 shows XRD results of the solid solution of K₃OBr and K₃OI.

FIG. 27 shows a relation between the lattice parameter of the synthesized solid solution and the halide composition.

FIGS. 28A-28B show a crystal structure of (FIG. 28A) K₃OCl (orthorhombic) and (FIG. 28B) K₃OBr (cubic). Both are from c-axis projection.

FIG. 29 shows XRD results of the solid solution of K₃OCl and K₃OBr.

FIG. 30 shows The relation between the anion size and tolerance factor in K₃OX (X=Cl, Br, I, or their mixture).

FIGS. 31A-31B show Temperature variable XRD results of K₃OCl from 300 to 500 K using Mo target as the X-ray source. The orthorhombic to cubic phase transition temperature matches the phase transition observed in DSC. *Peaks are from starting material KCl.

FIG. 32 shows a temperature-dependent ionic conductivity for K₃OX (X=Cl, Br, I).

FIG. 33 shows a temperature-dependent ionic conductivity for anion-mixing samples.

FIG. 34 shows XRD results of the solid solution of K₃OBr and Rb₃OBr.

FIG. 35 shows a comparison of halide mixing and cation mixing on the influence of lattice parameters for K₃OBr.

FIG. 36 shows a temperature-dependent ionic conductivity for cation-mixing samples.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

The term “comprising” and variations thereof as used herein is used synonymously with the term “including” and variations thereof and are open, non-limiting terms. Although the terms “comprising” and “including” have been used herein to describe various examples, the terms “consisting essentially of” and “consisting of” can be used in place of “comprising” and “including” to provide for more specific examples of the invention and are also disclosed. Other than in the examples, or where otherwise noted, all numbers expressing quantities of ingredients, reaction conditions, and so forth used in the specification and claims are to be understood at the very least and not as an attempt to limit the application of the doctrine of equivalents to the scope of the claims, to be construed in light of the number of significant digits and ordinary rounding approaches.

As used in the description and the appended claims, the singular forms “a,” “an,” and “the” include plural referents unless the context clearly dictates otherwise. Thus, for example, a reference to “an electrode” includes two or more such electrodes, reference to “a metal ion” includes two or more metal ions, and the like.

For the terms “for example” and “such as,” and grammatical equivalences thereof, the phrase “and without limitation” is understood to follow unless explicitly stated otherwise.

As used herein, the terms “optional” or “optionally” mean that the subsequently described event or circumstance can or cannot occur and that the description includes instances where said event or circumstance occurs and instances where it does not.

Ranges can be expressed herein as from “about” one particular value and/or to “about” another particular value. When such a range is expressed, another aspect includes from the one particular value and/or to the other particular value. Similarly, when values are expressed as approximations, by use of the antecedent “about,” it will be understood that the particular value forms another aspect. It should be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

As used herein, the term “substantially” means that the subsequently described event or circumstance completely occurs or that the subsequently described event or circumstance generally, typically, or approximately occurs. Still further, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate, effective amount will be readily determined by one of ordinary skill in the art using only routine experimentation.

In other aspects, as used herein, the term “substantially free,” when used in the context of a composition or component of a composition that is substantially absent, is intended to refer to an amount that is then about 1% by weight or less, e.g., less than about 0.5% by weight, less than about 0.1% by weight, less than about 0.05% by weight, or less than about 0.01% by weight of the stated material, based on the total weight of the composition.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to arrangement of steps or operational flow, plain meaning derived from grammatical organization or punctuation, or the number or type of aspects described in the specification.

The present invention may be understood more readily by reference to the following detailed description of various aspects of the disclosure and the examples included therein and to the Figures and their previous and following description.

### Solid-State Electrolyte

In certain aspects, disclosed herein is a solid-state electrolyte comprising a compound having a formula of A₍₃₋ₓ₎M_{y}B_{w}C_{z}. In such aspects, x can be from 0 to 1, including exemplary values of 0.1, 0.2, 0.3, 0.4, 0.5, 0.6, 0.7, 0.8, and 0.9. It is understood that x can have any value between any two foregoing values. In yet still further aspects, x is greater than 0.

In yet still further aspects, y can be substantially identical to x, or have a value of x/2, or x/3, or any values in between. For example and without limitations y can be 0, 0.033, 0.05, 0.066, 0.1, 0.133, 0.15, 0.166, 0.2, 0.233, 0.25, 0.266, 0.3, 0.333, 0.35, 0.366, 0.4, 0.433, 0.45, 0.466, 0.5, 0.6, 0.7, 0.8, 0.9.

In still further aspects, A can be any metal cation suitable for the desired application. In some aspects, A can be Na⁺, Li⁺, K⁺Cs⁺, or Rb⁺. In still further aspects, A is potassium cation. Yet, in another aspect, A is a sodium cation. In yet still further aspects, A is a Li cation.

In yet other aspects, M can be any known monovalent, divalent, or trivalent metal cation. For example, and without limitations, M can comprise at least one of Cs⁺, Rb⁺Mg⁺², Ca⁺², Ba⁺², Pb⁺², Sb⁺², Bi⁺³, Sr⁺², Al³⁺or even a small organic cation such as NH⁴⁺. In yet further aspects, M is Ba⁺². In yet still further aspects, M is Rb⁺. In still further aspects, the compounds described herein can be doped with the M element. Yet, in other aspects, where M is a monovalent cation, the compounds of formula A₍₃₋ₓ₎M_{y}B_{w}C_{z} can be formed by forming a solid mixture of A₃B_{w}C_{z} and M₃B_{w}C_{z}.

In still further aspects, B can be selected from VI group elements. Yet this is also exemplary and not limiting. B can also be selected from H⁻, F⁻, OH⁻. In yet other aspects, B can be represented by H₂O. In yet other exemplary and unlimiting aspects, B can be selected from O²⁻ or S²⁻, or their combination. In still further aspects, B is O⁻². While in yet other aspects, B is S⁻². In still further aspects, B can be from 0 to 1.

In still further aspects, C is one or more anions that can be selected from any known anions that support the desired application. In some aspects, C is a halogen. In such exemplary aspects, C can be selected from F⁻, Cl⁻, Br⁻, I⁻, or any combination thereof. Yet, in other aspects, C can be any other anion, for example, BH₄⁻, SO₄²⁻, CN⁻, NO₂⁻, or any combination thereof. In still further aspects, C can comprise two or more halides. In still further aspects, C can be from 0 to 1. If a combination of anions is present in C, for example, two or more halogens are present in the compound, the total amount of z is 1, but each of the anions can be present in any amount relative to each other. For example, if Cl and Br are present as C anions ratio of Cl to Br can be from 1:100 to 100:1, as long as their total amount results in z being 1. Similarly, C can comprise three or more halogens, for example, C can comprise Cl, Br, and I. In such aspects, the ratio of each halogen can be any ratio as long as their total amount results in z being 1.

Body-centered cubic-like (bcc-like) anion sublattices have been demonstrated to be favorable for fast-ion migration, as exemplified in some Li-ion conductors such as Li₁₀GeP₂S₁₂ and Li₇P₃S₁₁, as well as in Ag⁺ and Cu⁺ halides such as α-Agl. The bcc-like anion sublattices are much less packed compared to face-centered cubic (fcc) or hexagonal closed packed (hcp) sublattices. Therefore, and without being bound by any theory, it was hypothesized that it entails large channel space and weak interactions between the anion and the metal cation in the structures, promoting the fast-ion diffusion. The recent results on the Li/Na anti-perovskites fast-ion conductors such as Li₃OCl and Na₃OBr show the cations occupying octahedral sites can also migrate easily, although the mechanisms are still under debate.

In this disclosure, a search for K-ion superionic conductors among solids with bcc anion packing was conducted. It was found that out of 8699 K-ion crystal structures that have been recorded in the Inorganic Crystal Structure Database (ICSD), only 9 crystals have the bcc anion framework (not including structures that are close to bcc with minor distortions).

It was found that the following structures have the bcc anion framework: K₃OX (X=Au, Cl, Br, I, NO₂, CN), K₃(SbS₄), KCs, K₆C₆₀. Without wishing to be bound by any theory, it was suggested that the anti-perovskites K₃OX (X=Cl, Br, I, NO₂, and CN) material can be b a good candidate due to the electrochemical stability, synthesis, and bandgap. The other possible candidate is β-Ag₃SI, that is originated from the substitution on the anion sublattice of α-AgI has an anti-perovskites structure.

In some aspects, this disclosure is directed to potassium-based anti-perovskite materials. In some exemplary and unlimiting aspects, the perovskite materials of a K₃OX (X=Cl, Br, and I) type with halogen anion without the possible paddle wheel effect of NO₂ and CN anion has been selected. In yet other aspects, the compound disclosed herein has a formula of K₍₃₋ₓ₎M_{y}OI. Yet, in other aspects, the compound disclosed herein has a formula of K₍₃₋ₓ₎M_{y}OBr. In yet other aspects, the compound disclosed herein has a formula of K₍₃₋ₓ₎M_{y}OCl. In still further aspects, the compound disclosed herein has a formula of K₍₃₋ₓ₎M_{y}OClₐBr_{b} or K₍₃₋ₓ₎MyOBralb or K₍₃₋ₓ₎M_{y}OClₐI_{b}. In yet still further aspects, a and b can be in any ratio to each other from 1:100 to 100:1as long as the total of a and equals 1.

In still further aspects, the compounds disclosed herein have a crystalline structure up to about 100° C., about 150° C., about 200° C., about 250° C., about 300° C., about 350° C., or up to about 400° C.

In still further aspects, the compounds disclosed herein can exhibit a solid-solid phase transition at about 200° C., about 210° C., about 220° C., about 230° C., about 240° C., about 250° C., about 260° C., about 270° C., about 280° C., about 290° C., and about 300° C.

In still further aspects and as disclosed herein, the described compounds have an anti-perovskite structure. While in still further aspects, the disclosed compounds have a substantially cubic symmetry at room temperature.

In still further aspects, the compounds disclosed herein exhibit an ionic conductivity that is at least one order of magnitude, at least two orders of magnitude, or at least three orders of magnitude is higher than an ionic conductivity of a compound A₍₃₋ₓ₎M_{y}B_{w}C_{z} having substantially identical A, B, and C with x=0. In still further aspects, the compound exhibits an ionic conductivity from about 10-8 to 10-2 mS/cm² as measured at a temperature in a range from about 25° C.to about 300° C. In still further aspects, the compound exhibits an ionic conductivity of about 10⁻⁸, 10⁻⁷, 10⁻⁶, 10⁻⁵, 10⁻⁴, 10⁻³, or 10⁻² mS/cm² in an exemplary temperature range of about 25° C., about 30° C., about 50° C., about 70° C., about 100° C., about 150° C., about 170° C., about 200° C., about 220° C., about 250° C., about 270° C., or about 300° C. It is understood that the compound can exhibit a conductivity having any value between any two disclosed above values at any temperature value between any two disclosed above values. In still further aspects, the compound exhibits an ionic conductivity above from about 3.5 mS/cm² as measured at a temperature above 240° C.

In still further aspects, the compounds disclosed herein exhibit substantial reduction stability towards a metal anode, wherein the metal anode comprises a metal of A. In such exemplary and not limiting aspects, the metal anode can be K, Li, or Na, or alloys thereof.

In still further aspects, the solid-state electrolyte described herein can be provided as a pellet, a film, a powder, or a combination thereof. In still further aspects, the solid-state electrolyte can be molded to the desired shape. In still further aspects, the electrolyte is configured to be used in a primary battery, a secondary battery, or a combination thereof.

In some aspects, disclosed herein are the synthesis of the potassium-based anti-perovskites. Yet, in other aspects, the thermal properties and ionic conductivity of the potassium-based anti-perovskites materials are also disclosed. In yet other aspects, the disclosure is directed to the theoretical calculations based on density functional theory (DFT) and ab initio molecular dynamics (AIMD) simulations that were carried out to further understand the ionic conduction of the disclosed herein materials and to provide support for the structure and ion kinetics of the potassium-based anti-perovskites.

### Batteries

Also disclosed herein are batteries comprising an anode, a cathode, and disclosed herein solid electrolyte. In some aspects, the battery disclosed herein is a primary battery. Yet, in another aspect, the battery is a secondary battery.

In such aspects, the anode can comprise Li, K, or Na. In yet other aspects, the anode is a potassium anode. In yet other aspects, the anode is a lithium anode. In still further aspects, the anode is a sodium anode.

In still further aspects, the cathode material can be a composite material. In such aspects, if the electrochemical cell is a lithium electrochemical cell, any known in the art cathode materials that are useful in the Li cell can be utilized. If the electrochemical cell is K or Na cell, any known in the art cathode materials that are useful in Na or K cells can be utilized.

In some aspects, the cathode comprises copper, carbon, graphite, sodium, lithium, layered oxides, spinels, olivines, or any combination thereof.

Yet, in still further aspects, the cathode comprises a composite material comprising λ-MnO₂, LiMn₂O₄ spinel, olivine LiFePO₄, FePO₄, layered LiCoO₂ (LCO), LiNi_{y}Mn_{y}Co_{1-2y}O₂ (NMC), LiNiMnO₂, or any combination thereof.

In yet still further aspects, the cathode can comprise a LiFePO₄ composite cathode, a LiNi_{0.8}Co_{0.15}Al_{0.05}O₂, a LiNi_{1/3}Mn_{1/3}Co_{1/3}O₂, a LiNi_{0.4}Mn_{0.3}Co_{0.3}O₂, a LiNi_{0.5}Mn_{0.3}Co_{0.2}O₂, a LiNi_{0.6}Mn_{0.2}Co_{0.2}O₂, or a LiNi_{0.8}Mn_{0.1}Co_{0.1}O₂ composite cathode. In yet still further aspects, the cathode material can also comprise a poly(ethylene oxide), cellulose, carboxymethylcellulose (CMC), a polytetrafluoroethylene (PTFE), styrene-butadiene rubber (SBR), or a polyvinylidene fluoride binder, or a combination thereof.

In still further aspects, the cathode can comprise Prussian blue cathode and its analogs. In yet other aspects, the potassium-based cathodes can comprise K_{0.3}MnO₂ or K_{0.55}CoO₂. In still further aspects, the cathode can comprise any known and suitable for the desired application of polyanionic compounds with inductive defects, such as, for example, fluorosulfates have a reversible intercalation mechanism with K, Na, and Li, or K₃V₂(PO₄)₃, KVPO₄F, and the like. In still further aspects, the cathode materials can comprise oxygen, sulfur, or polysulfide materials. In still further aspects, the electrolytes disclosed herein can be used in K-O₂ and K-S batteries

In yet other aspects, the compounds disclosed herein can also be disposed or absorbed on a carbon paper.

In still further aspects, the batteries disclosed herein are designed to operate in about 65° C. to about 300° C.temperature range. In still further aspects, the batteries disclosed herein can operate at about 70° C., about 80° C., about 90° C., about 100° C., about 110° C., about 120° C., about 130° C., about 140° C., about 150° C., about 160° C., about 170° C., about 180° C., about 190° C., about 200° C., about 210° C., about 220° C., about 230° C., about 240° C., about 250° C., about 260° C., about 270° C., about 280° C., about 290° C., or about 300° C.

In still further aspects, the symmetric batteries using molten K electrodes and the disclosed herein electrolytes show an overpotential lower than about 100 mV, lower than about 90 mV, lower than about 80 mV, lower than about 70mV, lower than about 60 mV, or about or lower than about 50 mV at the current density of about 0.5 mA/cm²

### Methods

Also disclosed herein are methods comprising reacting a metal A with a salt comprising a cation A and a B, and i) a salt comprising the cation A and an anion C; at a temperature effective to form a compound having a formula A₃B_{w}C; wherein w is from 0 to 1, z is from 0 to 1; A comprises a metal cation comprising Na+, Lit, K+, Cs+or Rb+; B comprises O₂₋ or S²⁻; and C comprises F⁻, Cl⁻, Br⁻, I⁻, BH₄⁻, SO₄²⁻, CN⁻, NO₂⁻ or a combination thereof.

It is understood that any of the disclosed above B and/or C elements can also be utilized. For example, B can also be selected from H⁻, F⁻, OH⁻. In yet other aspects, B can be represented by H₂O.

In yet still further aspects, the methods can further comprise doping the compound A₃B_{w}C_{z} to form a compound of a formula A₍₃₋ₓ₎M_{y}B_{w}C_{z}, wherein: x is greater than 0 to 1; y is x, or x/2 or x/3; and wherein M is a monovalent, a divalent or a trivalent metal cation. In such aspects, M can be at least one of Cs+, Rb+Mg+2, Ca+2, Ba+2, Pb+2, Sb⁺², Bi⁺³, Sr⁺², Al³⁺ or even a small organic cation such as NH⁴⁺.

In still further aspects, where M is a monovalent cation, the methods can also comprise forming A₍₃₋ₓ₎M_{y}B_{w}C_{z} by forming a solid mixture of A₃B_{w}C_{z} and M₃B_{w}C_{z}.

Also disclosed are the methods of making batteries. In such aspects, an anode material comprising any of the disclosed anodes is combined with the disclosed herein solid electrolyte and a cathode material comprising any of the disclosed above cathodes.

By way of non-limiting illustration, examples of certain aspects of the present disclosure are given below.

### EXAMPLES

### Example 1

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is degrees C. or is at ambient temperature, and pressure is at or near atmospheric.

Materials: Potassium nitrate (KNO₃) (99.0%, Sigma-Aldrich) and potassium iodide (KI) (99.0%, Sigma-Aldrich) were dried under vacuum at 200° C. using a chemical drier (Sigma-Aldrich) for 24 hours before use. P50 carbon paper (Fuel Cell Store) was dried under vacuum at 120° C. Potassium (K) (99.95%, Alfa Aesar) was used directly. All the chemicals were stored in Ar filled glovebox.

Synthesis: K₃OI can be synthesized via a two-step reaction. Pure K₂O was first made with 1.011 g KNO₃ (10 mmol) and a 2.052 g K metal foil (52.5 mmol). 5% excess of K metal was used due to the evaporation of K during the synthesis. The mixture was placed on an alumina boat within a quartz tube under Ar flow. The sample was heated to 170° C. in 3 hours and kept at 170° C.for 12 hours. The synthesized 310.9 mg K₂O (3.3 mmol) and 498 mg KI (3.0 mmol) were weighted, ground for 10 mins, and pressed into a pellet. 10% excess of K₂O was used due to the loss of K₂O during the synthesis. The sample pellet was sealed in a silver tube at Ar atmosphere and heated to 330° C. in 2 hours, and kept at 330° C. for 12 hours. The sample was cooled naturally. For the synthesis of K₄OI₂, 198 mg K₂O (2.1 mmol) and 664 mg KI (4.0 mmol) were used. The sample was heated to 450° C. in 3 hours and kept at 450° C.for 15 hours.

The synthesis of K₃OI can also be accomplished using a facile one-step solid-state reaction. 101 mg KNO₃ (1.0 mmol) and 498 mg KI (3.0 mmol) were weighted and ground together. The mixed powder was loaded on 203 mg K metal foil (5.2 mmol) for good contact. 4% excess of K metal was used due to the evaporation of K during synthesis. All the operation was done inside the Ar atmosphere glove box (oxygen level <1.5 ppm; water level <0.5 ppm). The mixture was placed on an alumina boat within a quartz tube under Ar flow. The sample was heated to 170° C.in 3 hours. Then it was heated to 330° C. in 1 hour and kept at 330° C. for 3 hours. After the heating process, the sample was cooled naturally.

It was also found that K_{2.9}Ba_{0.05}OI can also be synthesized via the reaction mentioned above by replacing quantitative KI with BaI₂.

Previously K₃OI was synthesized using the following reaction at 330° C.

K₂O+KI=K₃OI (Eq. 1)

However, K₂O is not commercially available. Therefore, to prepare K₂O, K metal was reacted in KNO₃ for 12 hours at 170° C.:

5K+KNO₃=3K₂O+0.5N₂ (Eq. 2)

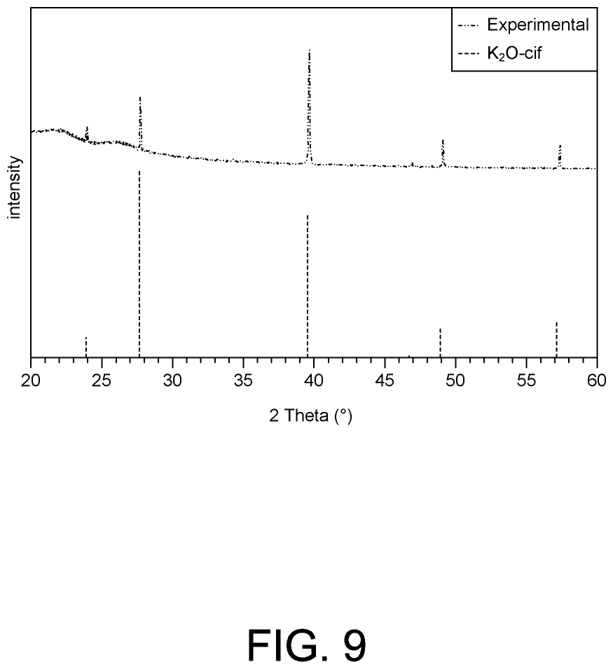

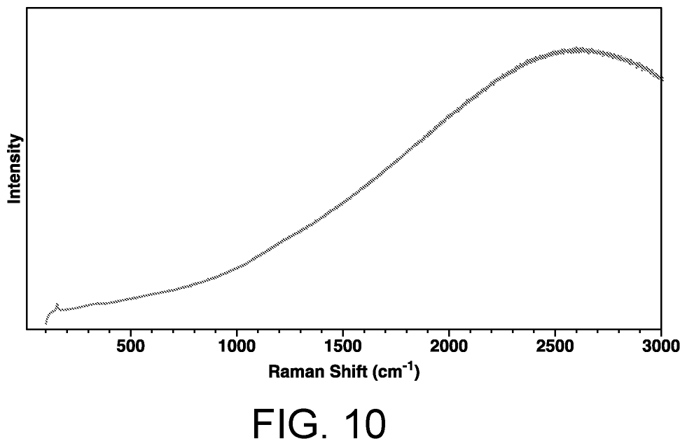

Due to the significant reducing ability of K metal and oxidizing ability of KNO₃, pure K₂O (FIG. 9 and FIG. 10) can be prepared in a short time without repeating the grinding and heating process.

Moreover, the two-step reaction can be simplified into a facile one-step reaction to synthesize K₃OI.

5K+KNO₃+3KI=3K₃OI+0.5N₂ (Eq. 3)

This reaction can be accomplished in 24 hours at 330° C.without repeating grinding and heating or high-energy ball milling. On the contrary, the previously reported synthesis of NaBOX (X=Cl, Br) from Na, NaOH, and NaX needed three times repeating grinding and heating. Also, the synthesis of NasOBH₄ needs a ball milling process that can be avoided in the disclosed herein processes.

### Example 2

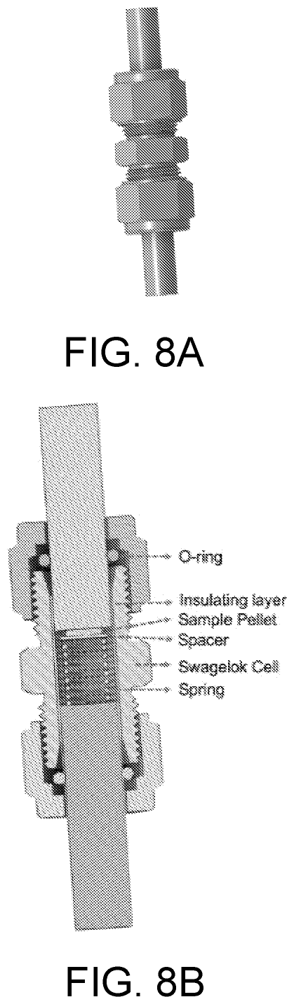

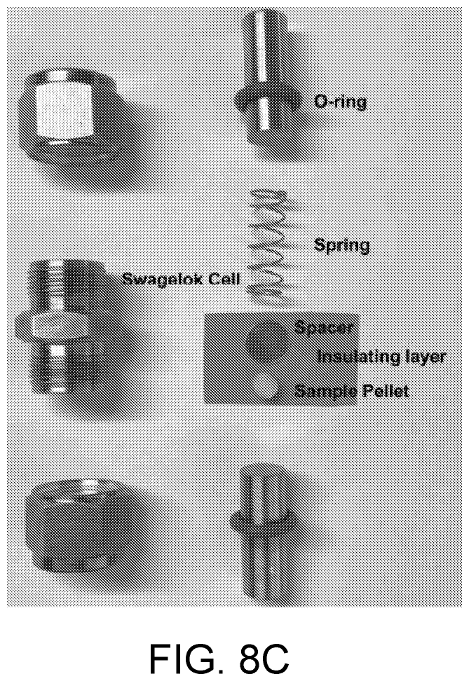

Characterization: The phase purity of the powder sample was characterized using an X-ray diffractometer (Bruker D8 Advance, Cu Ka source, 40 kV, 40 mA). Differential scanning calorimetry (DSC) was used under dry-N₂ flow. 5-10mg samples for DSC measurements were sealed by using Al hermetic pans in an Ar-filled glove box. The cooling and heating rates were 5° C. min-1. For the ionic conductivity test, the sample pellets were sintered at 300° C. for 15 hours. Pt was coated on both sides of the pellet by using a sputter coater to ensure sufficient electrical contact. Due to the air sensitivity of the sample, the AC impedance measurement was done with a homemade high temperature Swagelok electrochemical cell using a Gamry Reference 600 potentiostat. The details of the cell are shown in FIG. 8. An AC voltage with an amplitude of 20 mV was applied to the cell. The frequency range was from 1 MHz to 1 Hz. The temperature was controlled by a Thermo Scientific muffle furnace and was monitored by a digital thermocouple. The resulting data were fitted using the ZView software. The values of ionic conductivity were determined from the measured resistance by using the expression:

$$σ = \frac{L}{A R} \qquad ( 4 )$$

where L is the thickness of the electrolyte, A is the area of electrolyte, and R is the resistance fitted from the Nyquist plot using the ZView software.

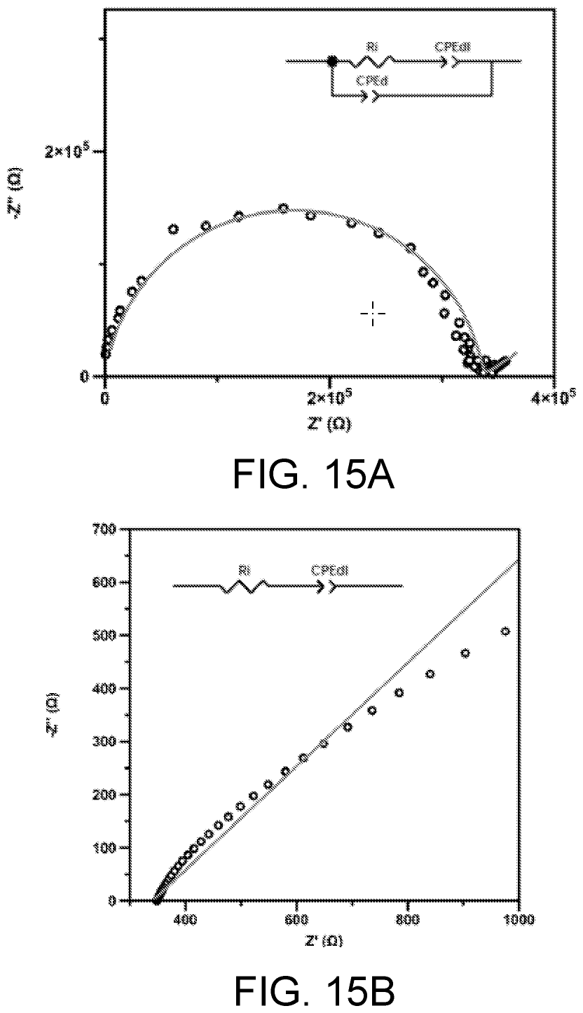

The details of fitting are shown in FIGS. 15A-15B. For the K/K_{2.9}Ba_{0.05}OI/K symmetric cell, K metal was firstly molten and adsorbed to P50 carbon paper on a heating plate at 250° C. The carbon paper was then punched into the desired size (˜0.2 cm²). The adsorbed K metal in the punched carbon paper is approximately 2 mg, and the corresponding theoretical capacity is 1.3 mAh. K_{2.9}Ba_{0.05}OI powder was hot-pressed into a pellet at 150° C.and 400 MPa. Then the pellet was sintered at 220° C. for 8 hours. The final relative density of the pellet is 94%. The prepared K metal@carbon paper was placed on both sides of the sintered K_{2.9}Ba_{0.05}OI pellet (˜0.28 cm², ˜1.5 mm) in the homemade high temperature electrochemical Swagelok cell. A compression spring was used to provide approximately 0.5 MPa pressure to ensure good contact between K metal and sample pellet.

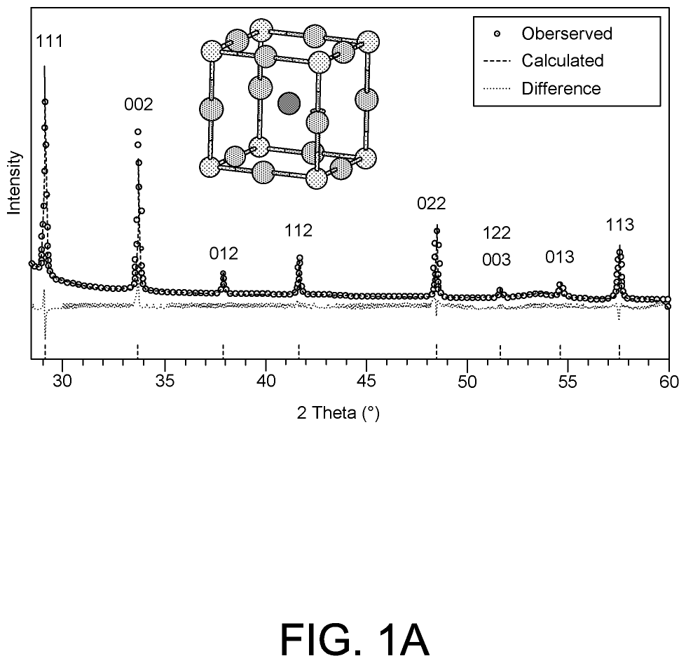

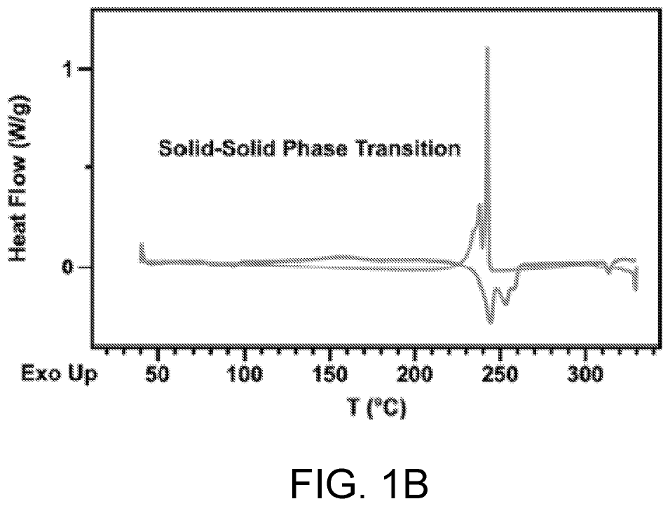

FIG. 1A shows an XRD pattern of synthesized K₃OI and the Rietveld refinement using space group Pm-3m cubic symmetry (a=b=c: α=β=γ=90°; K at 3d site, O at 1a site, and I at 1b site). The obtained lattice parameters are a(=b=c)=5.30713(4) Å and R_{wp}=9.21% Additional Rietveld refined atomic information of K₃OI is shown in Table 1.

TABLE 1
Rietveld refined atomic information of K₃OI

| Atoms | Wyckoff | x | y | z | Occupy | B_{eq} |
|---|---|---|---|---|---|---|
| K | 3d | 0.5 | 0 | 0 | 1.00(3) | 0.9(3) |
| O | 1a | 0 | 0 | 0 | 1 | 1.5(2) |
| I | 1b | 0.5 | 0.5 | 0.5 | 1 | 0.0(7) |

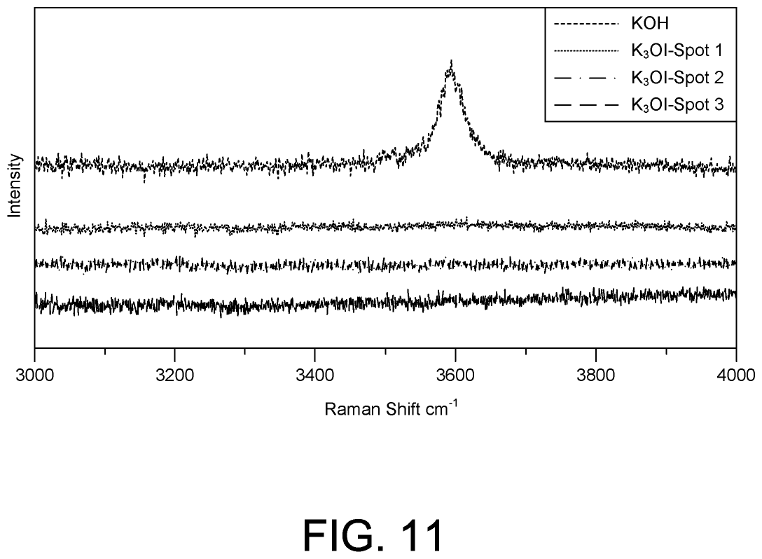

To avoid the possible interference of hydroxide OH⁻ in the synthesized anti-perovskite (as seen in some cases of lithium oxyhalides), hydroxides were not used as starting reactants, and the preparation was carried out in sealed quartz tubes with the sample handled in an argon-filled glovebox. Raman spectroscopy was used to confirm that no-OH groups are present in the potassium anti-perovskite material disclosed herein (FIG. 11).

In still further aspects, thermal analysis (by use of the differential scanning calorimetry) was used to observe the structural changes of the materials, and the result is shown in FIG. 1B. For the pristine K₃OI, there were three endothermic peaks at 245, 254, and 258° C. during heating. The previous study of Li— and Na— anti-perovskites also observed phase transitions at a similar temperature (Li₃OCl at 320° C., Na₃OBr at 255° C., and Na₃OBH₄ at 240° C.). The previous study contributed those phase transitions to melting and crystallization. However, without wishing to be bound by any theory and according to the results obtained herein, K₃OI keeps crystalline structure up to 350° C. Again without wishing to be bound by any theory, it was hypothesized that the phase transitions shown in DSC are not related to the melting or re-crystallization of the sample. Since [K₆O] octahedra does not have any tilting, K₃OI is already at the cubic symmetry at room temperature, and therefore the phase transition shown herein should be a solid-solid phase transition without changing the space group.

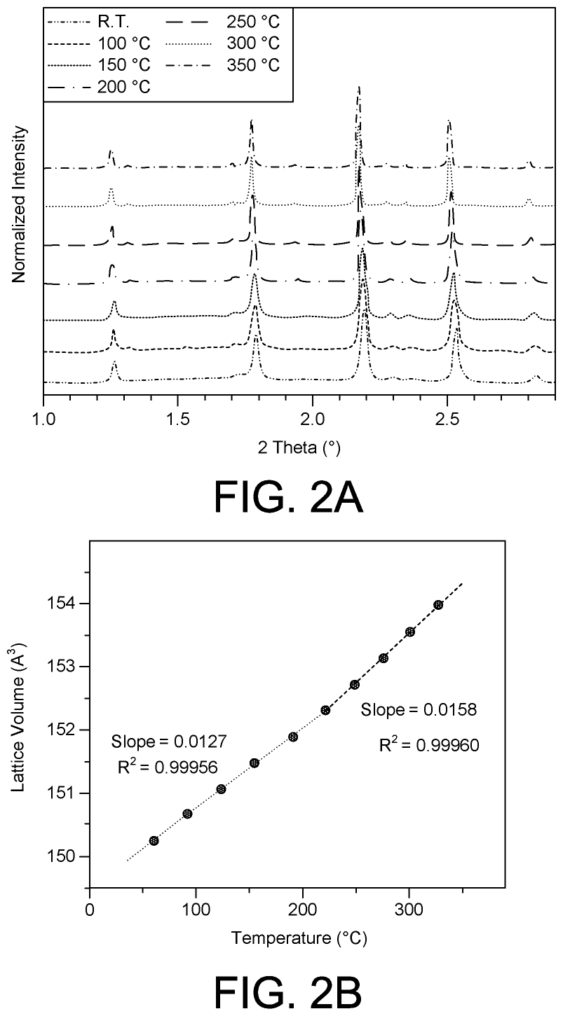

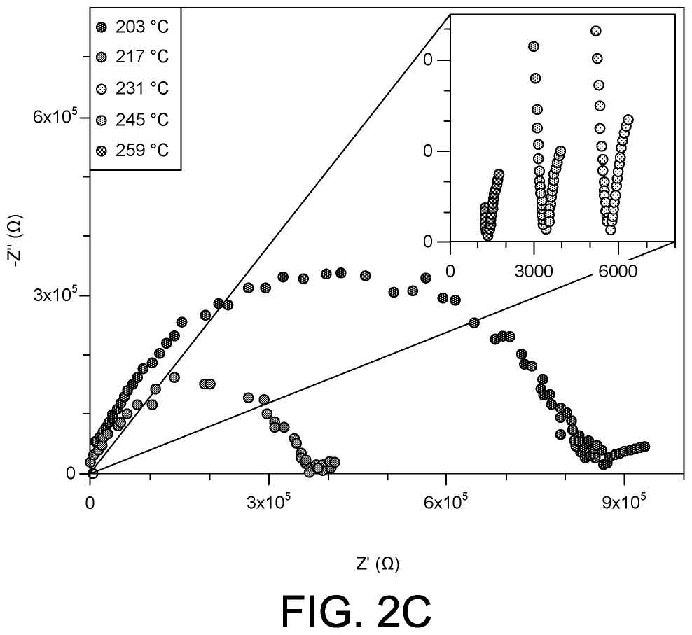

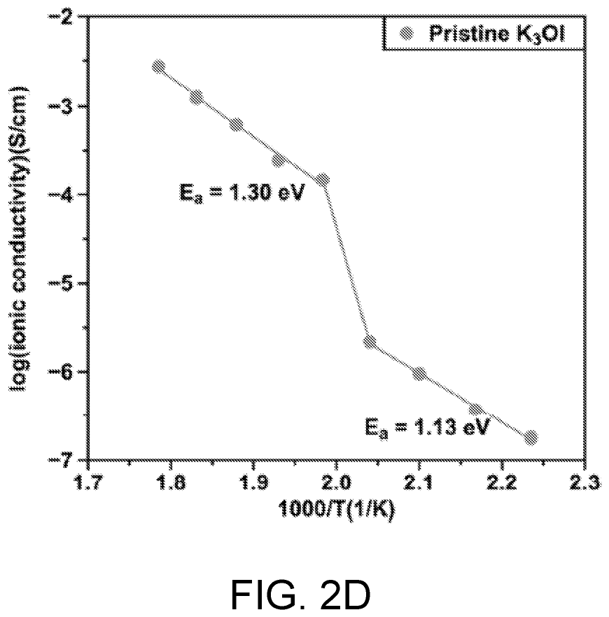

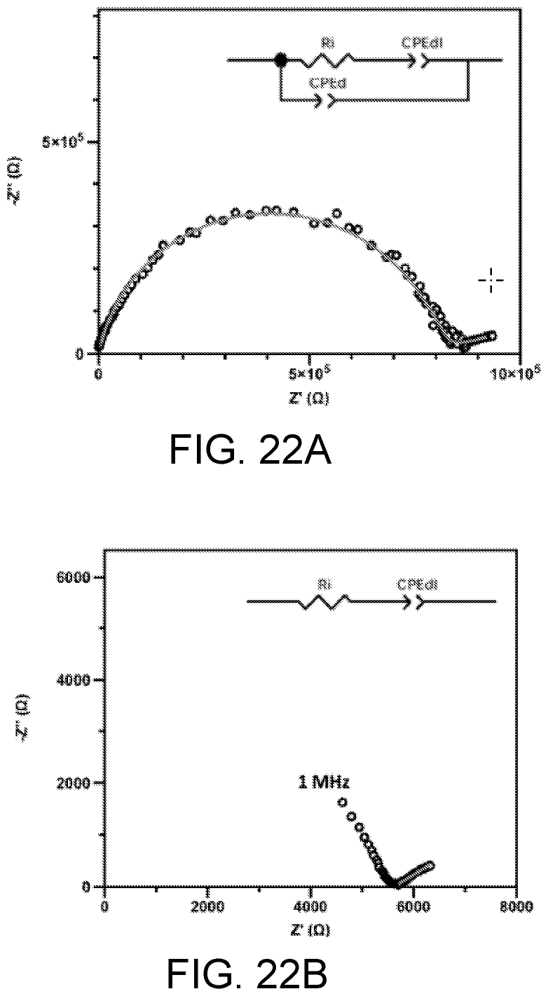

To study how the structure of K₃OI changes with temperature, temperature-dependent synchrotron XRD was performed. The results are shown in FIGS. 2A-2D. The diffraction pattern did not change during heating from room temperature to 350° C. and only the peak position shifted to the left due to the thermal expansion of the K₃OI lattice (FIG. 2A). This result shows that K₃OI remained crystalline up to 350° C. The unchanged diffraction pattern indicates that K₃OI maintained its original cubic space group during heating. It also excludes the possibility that K₃OI had any symmetry change. As shown in FIG. 2B, there is a slope change near 240° C., matching the phase transition temperature shown in the DSC (FIG. 1B). The ionic conductivities of the as-prepared K₃OI samples were measured by the AC impedance method, as shown in FIGS. 2C and 2D. Pt was sputtered on both sides of the sample pellets. Due to the air sensitivity of the sample, the AC impedance measurement was done with a homemade high-temperature Swagelok electrochemical cell (FIGS. 8A-8C). Some additional Nyquist plot fitting using Zview software are shown in FIGS. 22A-22B.

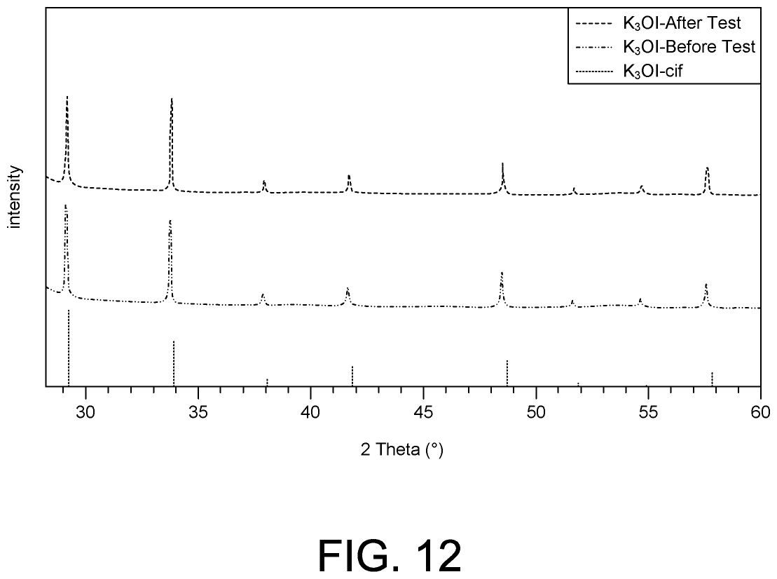

The unchanged XRD of the sample after sintering and testing (FIG. 12) has shown that the sample does not have any irreversible degradation. The ionic resistance of pristine K₃OI decreases from 3.7×10⁵Ω to 5.6×10³Ω with elevated temperatures from 217° C.to 231° C., corresponding to the ionic conductivity increasing by two orders of magnitude. Meanwhile, the activation energy of the high-temperature phase becomes 1.30 eV from 1.13 eV of the low-temperature phase.

### Example 3

Density functional theory (DFT) calculations were carried out using Perdew-Burke-Ernzerhof (PBE) generalized gradient approximation (GGA) implemented in the VASP package. The projector augmented wave (PAW) pseudopotential method is used. A dense Monkhorst-Pack k-point mesh is chosen according to the size of the studied structure for each calculation. The cutoff energy is 550 eV. The energy convergence is set to 10⁻⁶ eV, and the force convergence is set to 0.001 eV/Å. Structures of the material are fully optimized without the symmetry constraint. Calculated phonon frequencies using density functional perturbation theory (DFPT) confirm that the optimized structure is lattice dynamically stable.

To study the K+transport of the material, ab initio molecular dynamics (AIMD) simulations are conducted using 2×2×2 supercells (w/o one K⁺ vacancy) that lasted over 100 ps at a time step of 2 fs. The first 10-20 ps allow the system to reach thermal equilibrium before collecting the structural data at each time step. NVT ensemble (with constant volume) is used at high simulated temperatures (800, 1000, 1100, and 1200 K) to speed up the ion hopping process. The diffusivity (D) at each temperature is obtained by fitting to the calculated mean squared displacement (MSD) from the collected MD data according to

$$D = {lim}_{t \to ∞} [ \frac{1}{6 t} 〈 {[ \vec{r} ( t ) ]}^{2} 〉 ] \qquad ( 5 )$$

where \vec{r}(1) is the displacement vector of K⁺ at time t. The conductivity (σ) is then calculated from the Nernst-Einstein relation

$$σ = D \frac{N {e}^{2}}{k T} \qquad ( 6 )$$

with N being the number of ions per cm3. Other symbols have their customary meanings. The Arrhenius relationship

$$D = A exp ( \frac{{E}_{a}}{k T} ) \qquad ( 7 )$$

is used to fit to the diffusivities at different temperatures and extrapolate to the value of room temperature. The prefactor A and activation energy Eₐ are the fitting parameters in the relation.

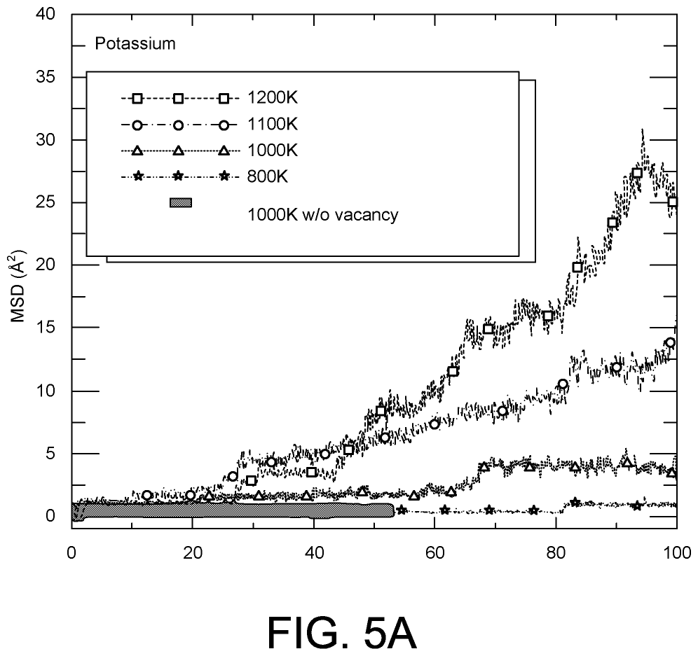

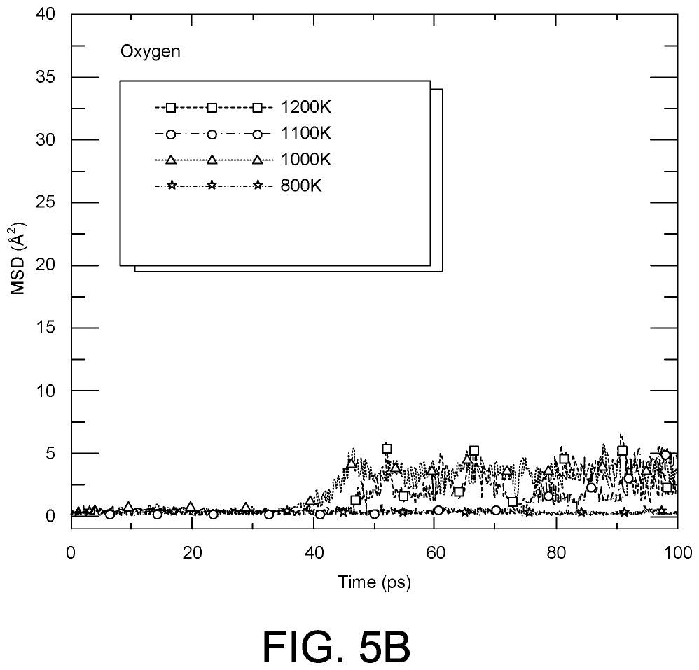

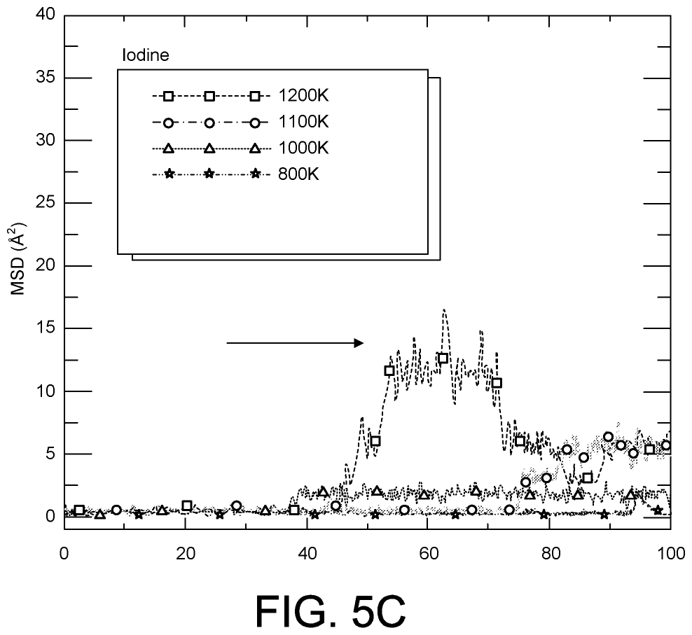

To study the phase transition and partial melting of the material, AIMD simulations with an NpT ensemble are conducted to simulate the experimental condition. A typical simulation lasts about 100 ps with a 1 fs time step. Data collection starts after the first 20-30 ps to allow the system to reach thermal equilibrium. Collected free energy and structural data at each time step are then subjected to further analysis, e.g., the pair distribution function studies. The probability distribution for different ion species in the material is computed using the MD data at 800 and 1200 K. The code reads through the snapshots of the material structure over the specified time period with a time step of 4 fs and counts the probability for a species present at each grid point in 3D space. For each phase region (as shown in FIG. 5), the PCF of different species pairs are calculated using MD data (snapshots of the structure) over the corresponding time range.

To understand the K-ion diffusion and the observed phase transition of K₃OI , the first-principles modeling and simulations on the material were performed as described above. The structure models for K₃OI were built with and without the K vacancy.

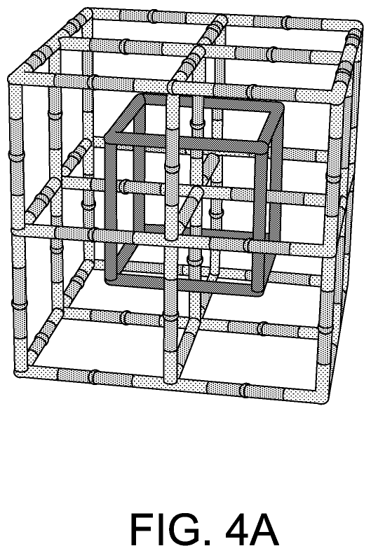

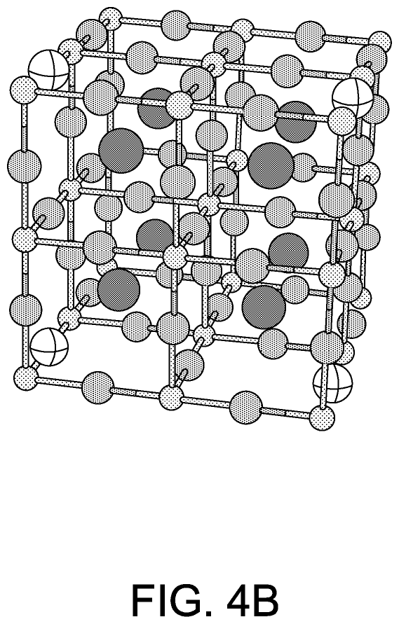

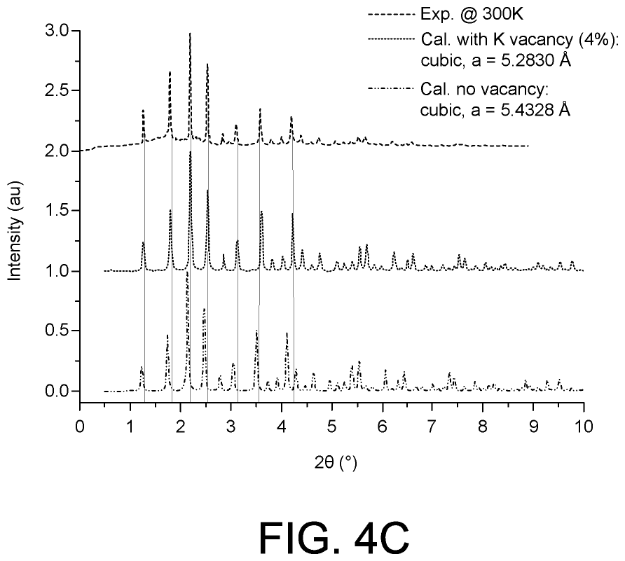

The stability of K₃OI as a function of temperature was studied. The observed phase transition was characterized in order to understand the mechanism of K⁺-ionic conductivity. The optimized structures of K₃OI, with and without the K⁺ vacancy, are shown in FIGS. 4A and 4B. K₃OI adopts a cubic phase for its unit cell in both cases. It was found that the DFT-optimized lattice parameter, a=5.2830Å, of the structure containing the K vacancy agrees much better with the experimental value (with 0.4% relative difference) than the optimized lattice parameter, a=5.4328Å, of the defect-free structure (with 2% relative difference). Simulated XRDs using these structural models agree very well with the experiment, as shown in FIG. 4C. It was found that the simulated XRD of the vacancy-containing model agrees better with the experiment, suggesting that the synthesized material contains K⁺ vacancies.

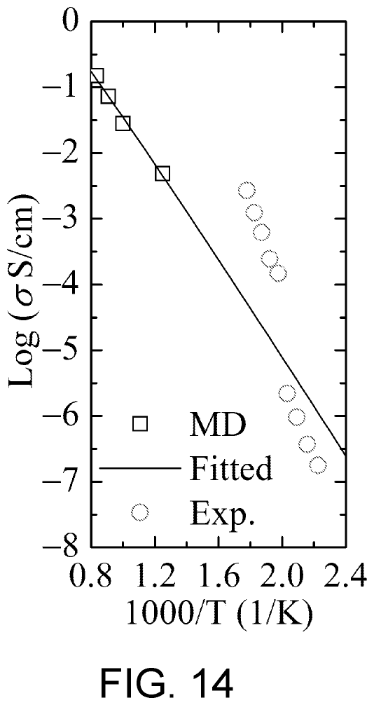

Using the disclosed herein structures, molecular dynamics simulations (MD) were conducted to study the K⁺ transport (FIG. 5). Without wishing to be bound by any theory, it was found that the K⁺ vacancy defect is necessary for the fast-ion conduction of K⁺ in K₃OI. This is shown by the calculated mean squared displacement (MSD) in FIG. 5, where a very large MSD of K⁺ is observed at high simulated temperatures (e.g., 1200 K) for the vacancy-containing structure, while zero MSD of K⁺ is found at the same temperature for the defect-free structure. The calculated and extrapolated ionic conductivities of the material at different temperatures agree well with the experimental measurements, as shown in FIG. 14. Large displacements of O and I are observed starting at about 40 ps at high simulated temperatures (1000, 1100, and 1200 K in FIG. 5), indicating a phase transition, which significantly enhances the K⁺ conductivity. On the other hand, no phase transition is observed at the low simulation temperature (e.g., 800 K in FIG. 5).

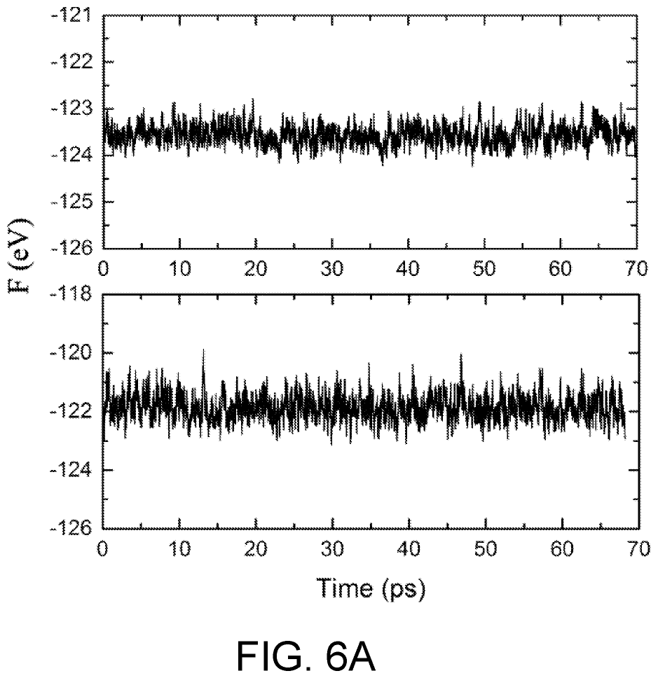

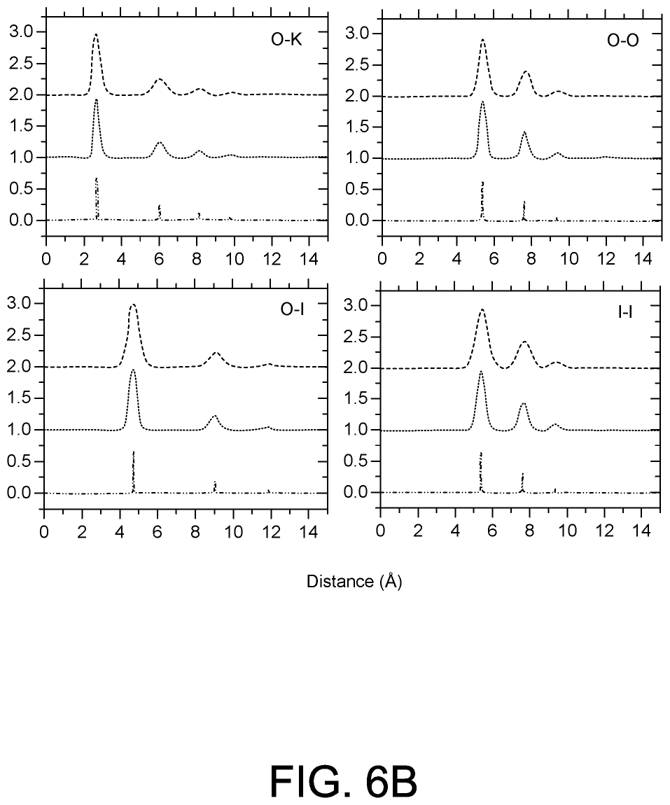

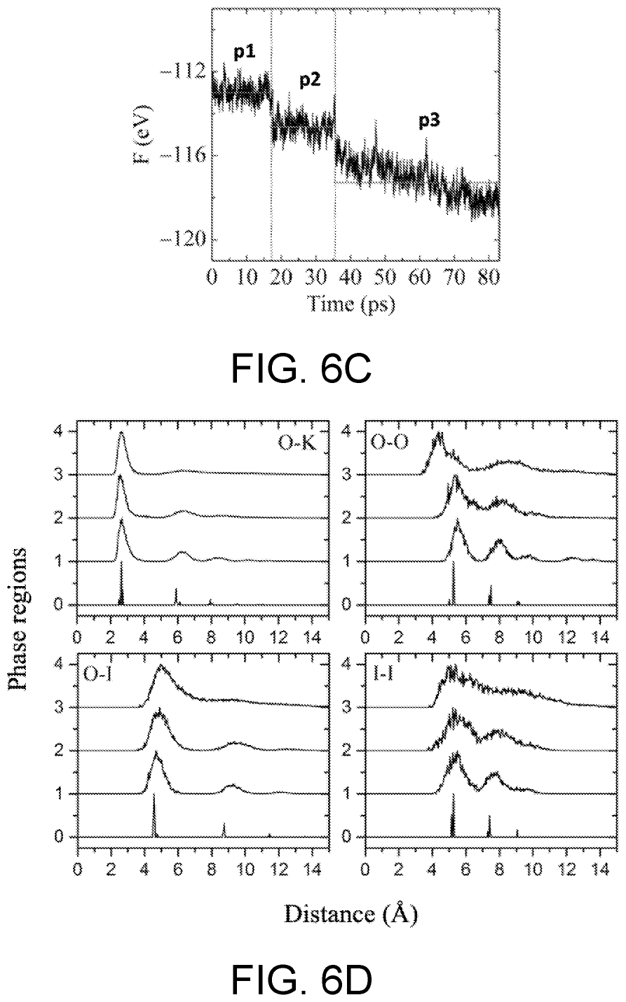

Given the importance of the vacancy defect and the phase transition for the superionic conductivity of K₃OI, further MD simulations under experimental conditions were carried out, as shown below, to characterize the observed phase transition of the material. With the defect-free structure, there is no phase transition at room temperature (300 K) and even at a high temperature of 600 K (≈325° C.), as shown by the calculated free energy profile in FIG. 6A. Further pair distribution function (PDF) analysis suggests the same, as shown in FIG. 6B. On the other hand, with the vacancy-containing structure, simulation at 600 K already shows phase transition according to the calculated free energy in FIG. 6C. It is found that such phase transition is diffusive (stepwise) in nature. As shown by the PDF analysis in FIG. 6D, all the long-distance peaks of O-K disappear. Three-phase regions (p1, p2, and p3) are identified in FIG. 6C. The long-distance peaks of O-I and I-I gradually disappear, suggesting diffusive behavior of the I-sublattice, which is consistent with the observed large MSD of I in FIGS. 5A-5C at high simulation temperatures. Shifting of the O-O peaks throughout the phase transition is due to the distortion and rotation of the corner-sharing [K₆O] octahedra, resulting in the reduction of the neighboring oxygen distances.

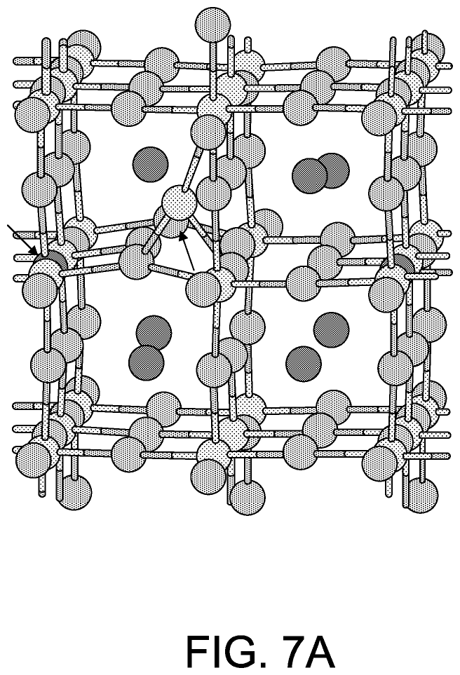

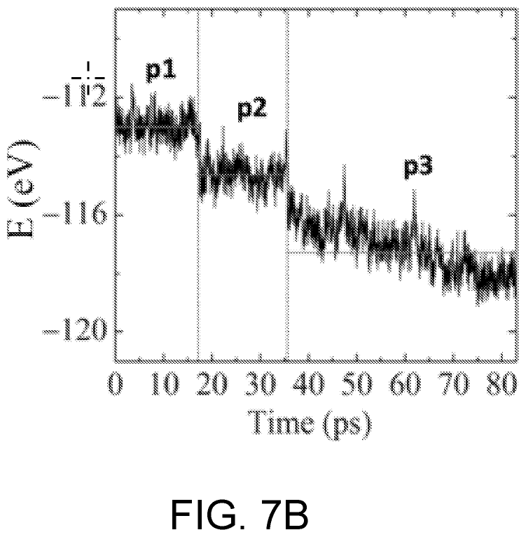

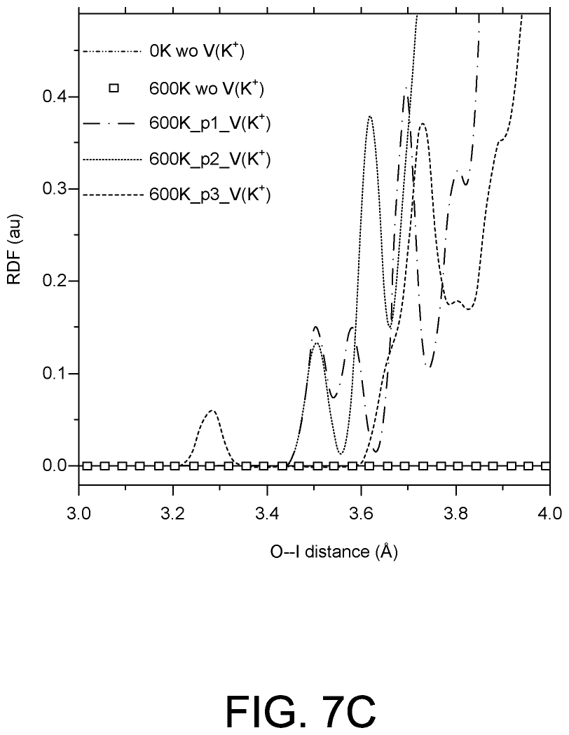

Further analysis of the MD data reveals that the phase transition of the material is triggered by iodine moving toward the K+-vacancy site, as shown in FIG. 7A. Given the larger ionic radius of I⁻ (2.06Å) than that (1.52Å) of K⁺, the neighboring oxygen originally at the corner of the unit cell is pushed away when the I⁻ moves close to the vacant K⁺ site, leading to the move of [K₆O] octahedra from its original position (FIG. 7A). This relocation of [K₆O] octahedra may facilitate the movement of K⁺, which results in an increase in ionic conductivity. In the structure shown in FIG. 4B, the distance from the I-site at the center of the cubic unit cell to the vacant K⁺ site is (\sqrt{2/2})a≈3.7Å which is consistent with the large MSD value (3.7²≈14Å²) observed for I⁻ at about 40 ps in FIGS. 5A-5C. Indeed, as shown by the PDF analysis in FIG. 7B, the O-I peaks appear in such distance range in all three phase regions. These results are shown in FIG. 6C. It was found that there is no such peak in the defect-free structure at both 0 and 600 K. Further PDF studies of this phase transition, such as neutron diffraction and solid-state NMR, are under conducted.

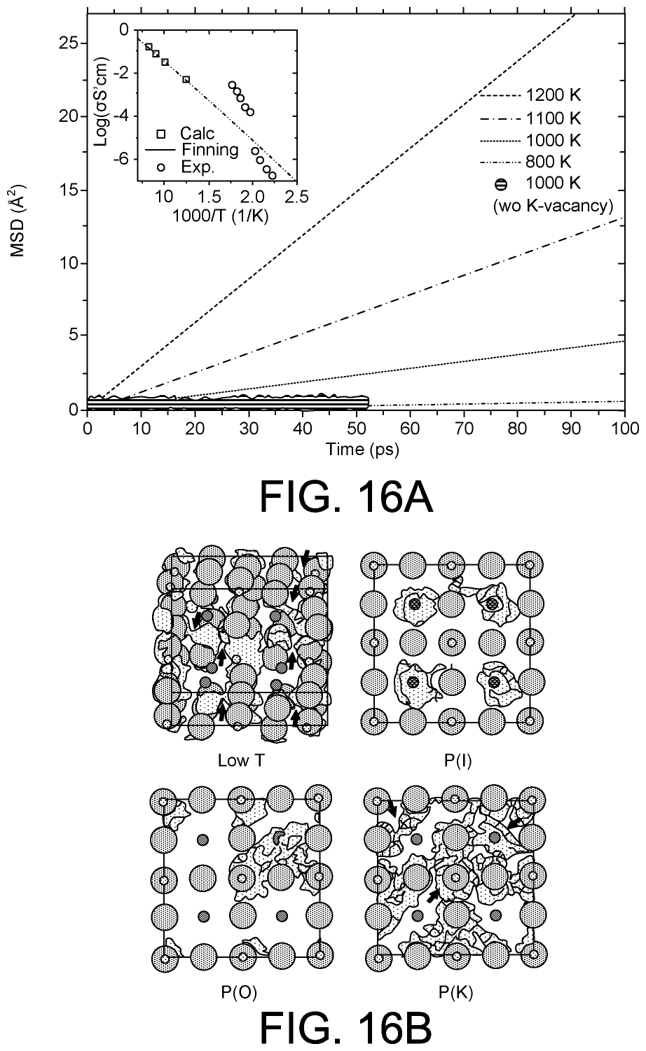

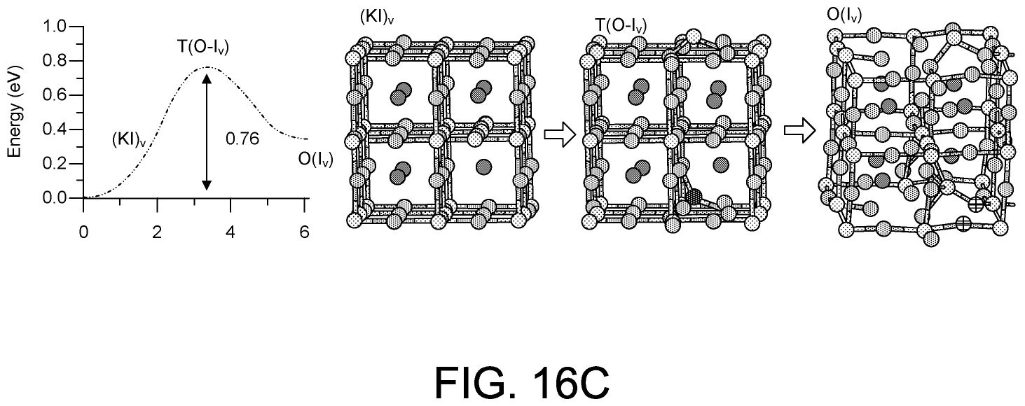

Based on the two structure models, AIMD simulations were further used to calculate the diffusivity and ionic conductivity of K₃OI. Using the same method as reported previously, ionic conductivities have been computed at a few high simulation temperatures and extrapolated to other temperature values. It is found that, without the K vacancy, the K-ion diffusion in the structure disappeared, as shown by the calculated mean squared displacement in FIG. 16A. With the presence of the K vacancy in the structure, the calculated ionic conductivities of the material agree quite well with the experimental values, especially in the intermediate and low temperature range (inset of FIG. 16A). These results suggest that the defect-containing model provides a good description of the material in practice.

Without wishing to be bound by any theory, it was hypothesized that the reason for the phase transition of K₃OI at the high temperature could be similar to the ion kinetics in the system with the presence of K vacancies, which can be studied by calculating the probability distribution function (PDF) for different ionic species. As shown in FIG. 16B, at the low simulation temperature (Low T), K-ions migrate via the vacancy sites, and there is no local disordering in the O-I sublattice. At high simulation temperatures, local anion disordering is activated with the I-ion migrating to the neighboring vacant site and O-ion migrating towards the vacated I-site, as shown by the calculated PDFs of P(I) and P(O), respectively, in FIG. 16B. Still further, such anion disorder can be directly seen by the structure snapshot from the simulation (see FIGS. 7A and 7B) as well as the change in the calculated radial distribution function, where new peaks appear at short I-O distances when the disorder occurs (see FIG. 7C). Thus, at high temperatures, as shown by the calculated P(K) in FIG. 16B and without wishing to be bound by any theory, K-ions can migrate not only via the K-vacancies but also through the relatively large vacancies around the disordered I-O sites, which is hypothesized to enhance the K-ion transport in the material.

To evaluate the activation energy of the local I-O disorder observed in the high-temperature simulation, the energy barrier of oxygen moving to a vacated iodine site using the solid-state nudged elastic band method involving both atomic and cell degrees of freedom was calculated. To keep the neutrality of the K-vacancy-containing system, a nonstoichiometric system of K_{2.875}OI_{0.875} with KI deficiency was used. Formation of a local anion disorder state O(Iv) is shown in FIG. 16C. The calculated barrier is 0.76 eV which is well below the measured activation energy of K-ion hopping in the material (see FIG. 16B). Without wishing to be bound by any theory, it was suggested that such disordering can happen at high temperatures and be responsible for the observed phase transition of the material. Still, further, these fundings were used to explain why the calculation in FIG. 16A overestimates the ionic conductivity of the low-temperature phase while underestimates that of the high-temperature phase since data points with and without the presence of the anion disordering are used altogether to extrapolate the ionic conductivities throughout the temperature range.

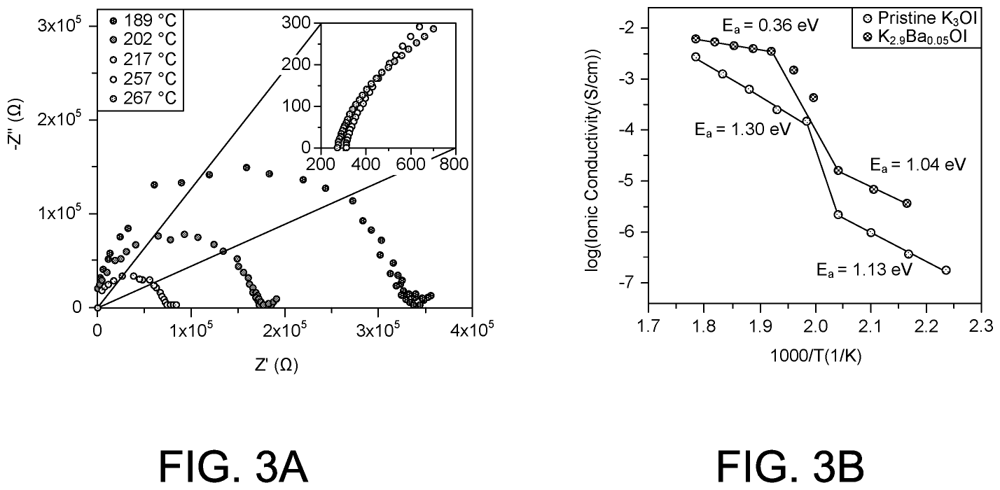

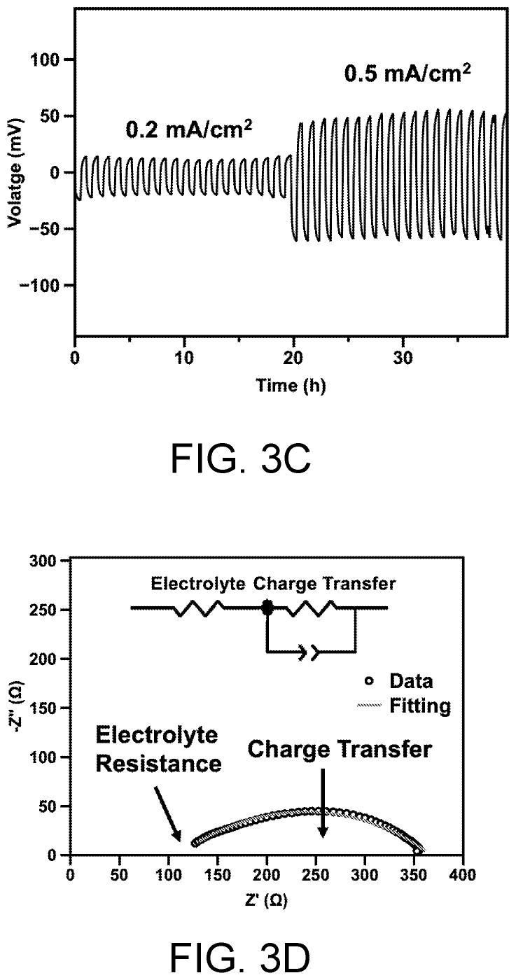

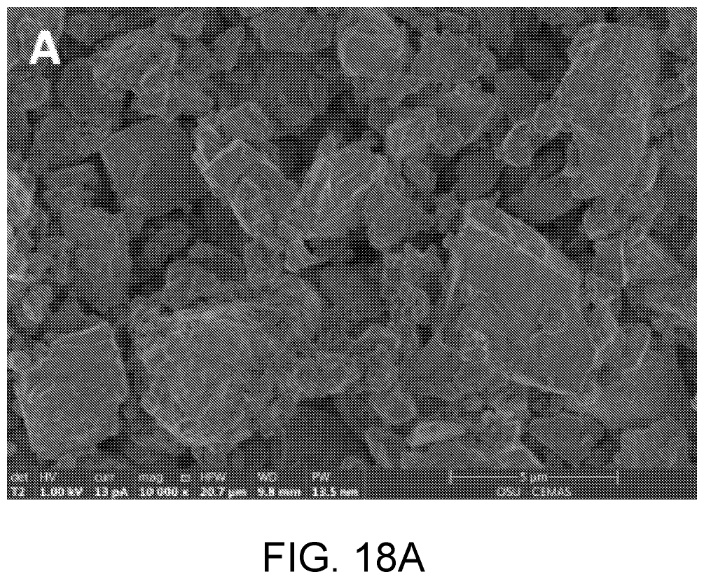

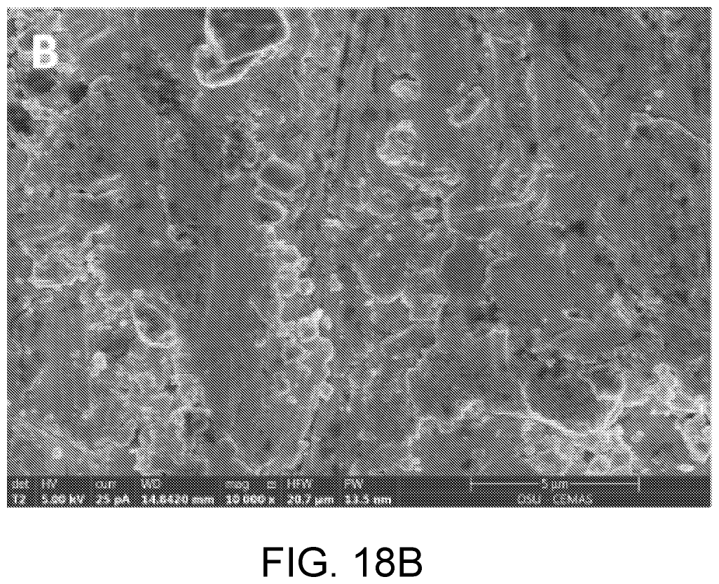

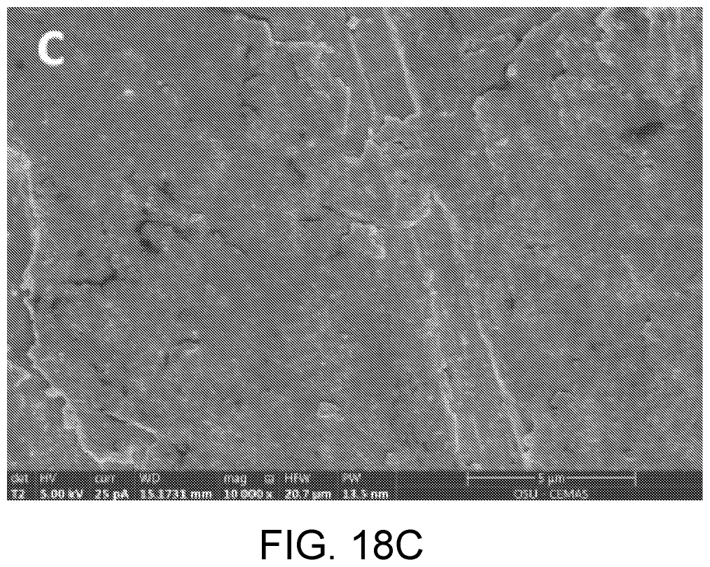

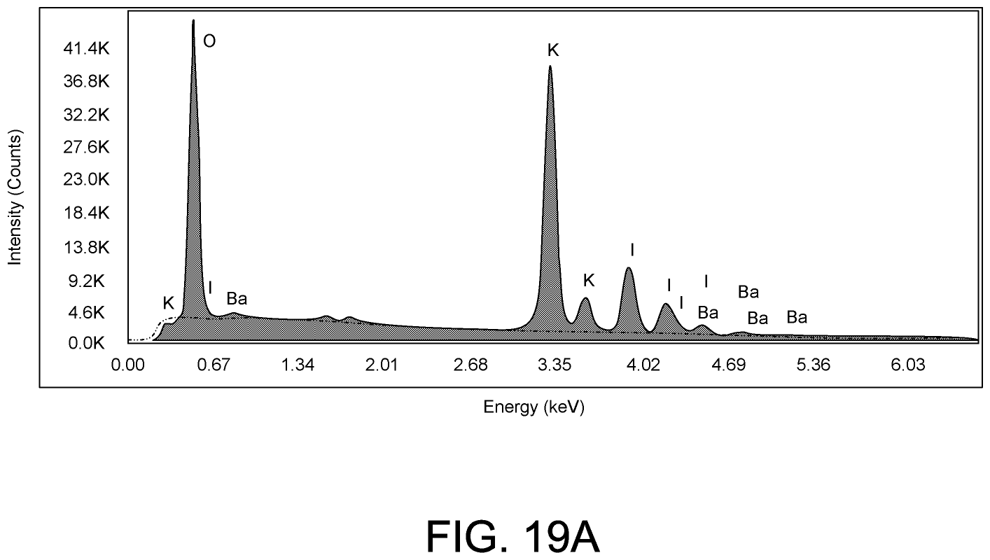

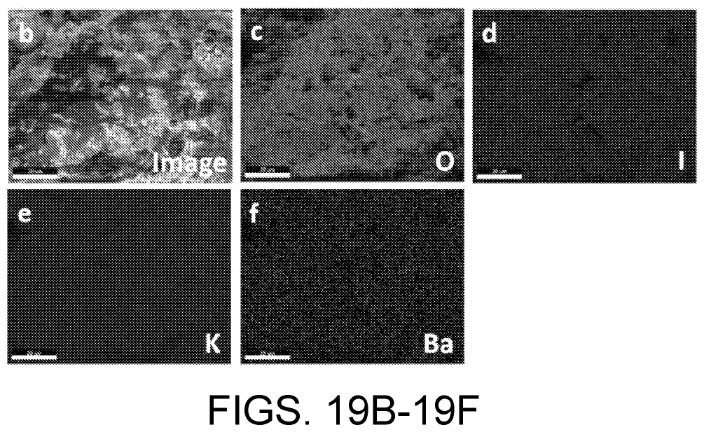

Still further based on the determination of K-vacancy role in fast-ion diffusion of the material, a way to tune the defect and the ionic conduction of the material was done by doping a multivalence cation of Ba²⁺ in K₃OI. Ba²⁺ was chosen due to its substantially similar size of 1.48 Å compared to that (1.52 Å) of K⁺. Without wishing to be bound by any theory, it was assumed that the dopant can occupy a K site in the structure. The measured ionic conductivities of the Ba-doped K₃OI-K_{2.9}Ba_{0.05}OI are shown in FIGS. 3A and 3B. K_{2.9}Ba_{0.05}OI showed one order of magnitude increase in the ionic conductivity compared to that of the pristine K₃OI at low temperatures. Upon heating, K_{2.9}Ba_{0.05}OI not only entails a significantly higher ionic conductivity than that of K₃OI but also has a greatly decreased activation energy of 0.36 eV. The result again suggests that K vacancies and the possible anion disorder activated at high temperatures can promote the fast-ion diffusion and reduce the migration barrier in the material. The SEM images of powder sample and pellet samples of K_{2.9}Ba_{0.05}OI material are shown in FIGS. 18A-18C and the compositional analysis are shown in FIGS. 19A-19F.

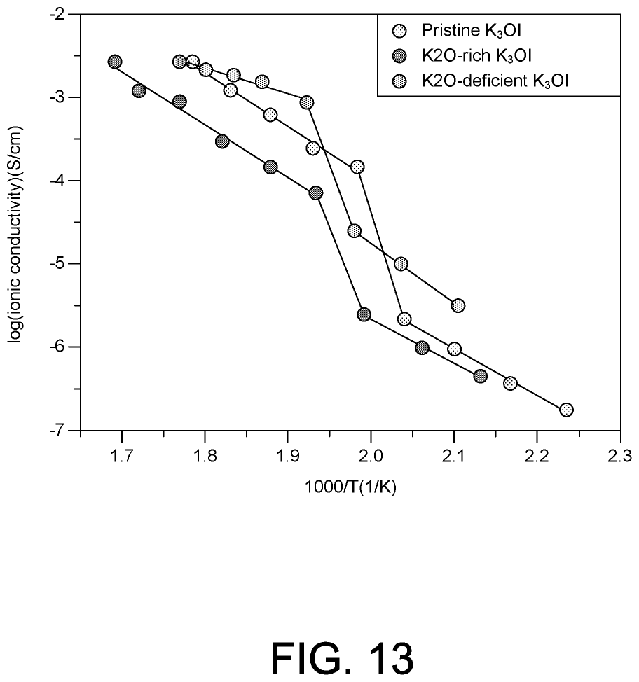

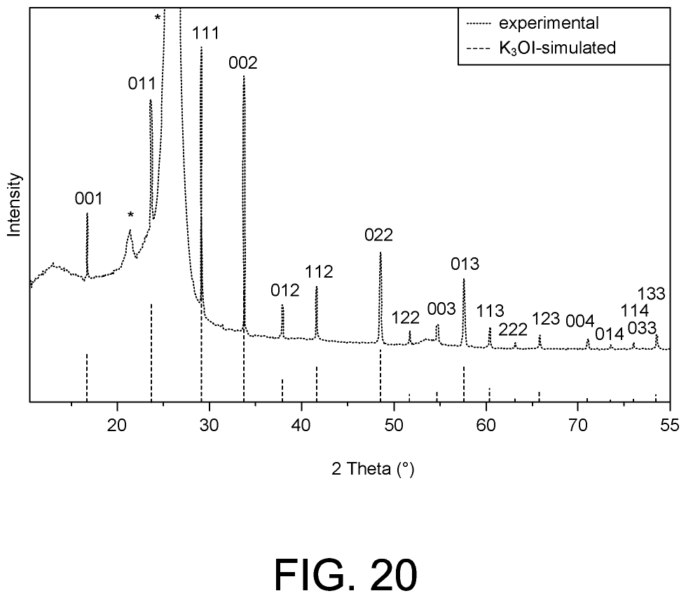

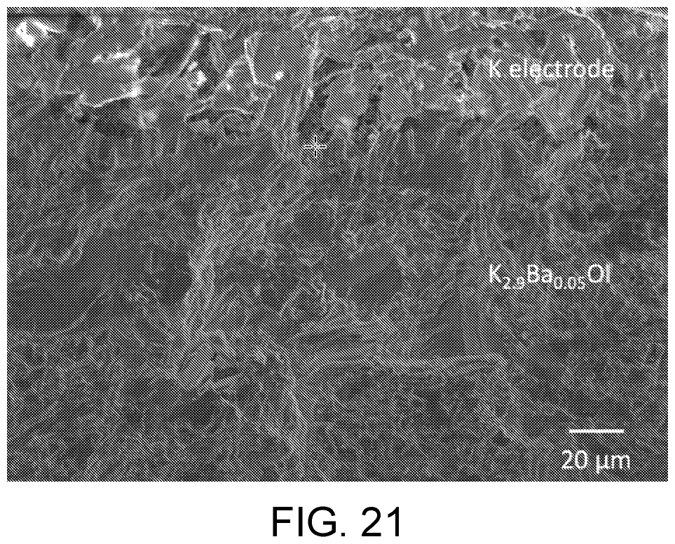

Some additional data showing Arrhenius plots of the ionic conductivity for pristine K₃OI, K₂O-rich K₃OI, and K₂O-deficient K₃OI samples is demonstrated in FIG. 13. The XRD images of the synthesized K₃OI are shown in FIG. 20.

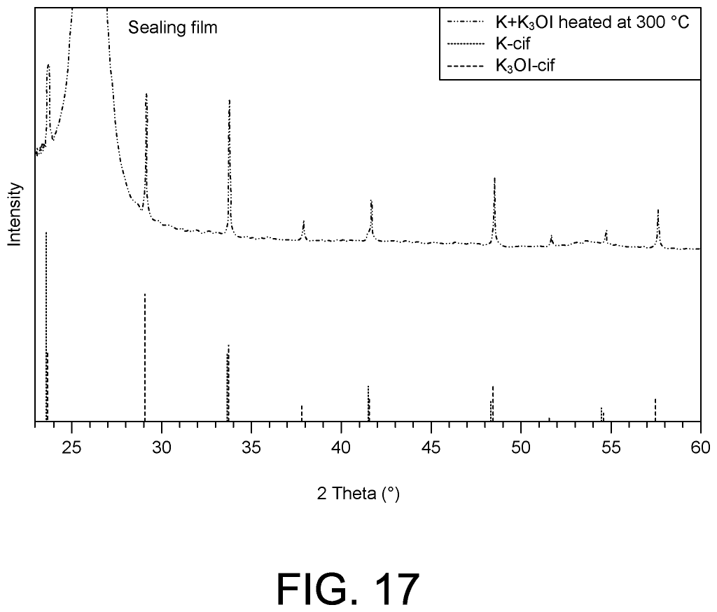

Still, further, it was found that K₃OI has relatively high reduction stability toward K metal. Due to the strong reducing ability of K metal, it has been a great challenge to find a stable liquid electrolyte for K metal batteries. Even the commonly used alkali metal solid-state electrolytes, such as Li₁₀GeP₂S₁₂ (LGPS), LPS, Na₃PS₄, and Li₇La₃Zr₂O₁₂ (LLZO), are not intrinsically stable toward Li or Na metal. For K₃OI, however, the oxidation state of oxygen and iodine is −2 and −1, respectively. It means that they cannot be further reduced by K metal or other K-ion-containing anodes. The unchanged XRD (FIG. 17) of K₃OI powder heated with K metal at 300° C.for 12 hours also supports its stability against K metal.

### Example 4

To demonstrate the implementation of the potassium anti-perovskite into a battery system, K/K_{2.9}Ba_{0.05}OI/K symmetric cell was fabricated. Pellet was prepared through hot pressing at 150° C.and 400 MPa, then sintering at 220° C.for 8 hours. The final relative density of the pellet is 94%. The prepared K_{2.9}Ba_{0.05}OI pellet (6 mm in diameter and thickness of ˜1.5 mm) was used as an electrolyte, and K metal (˜2 mg) adsorbed in a piece of carbon paper was used as an electrode. Carbon paper was used to prevent any leakage of molten K. The cycling performance of this cell at 270° C. is shown in FIG. 3C. At a current density of 0.2 mA/cm², the overpotential was kept at approximately 20 mV during K metal plating/stripping. At a current density of 0.5 mA/cm², the overpotential only increased to 50 mV. AC impedance spectroscopy was applied to study the origin of the overpotential. From high frequency to low frequency, the Nyquist plot (FIG. 3D) shows an electrolyte resistance and an RC circuit from the charge transfer process. The Nyquist plot did not show any contribution from the SEI layer, which confirms the reduction stability of K₃OI with K metal. The detailed fitting values are summarized in Table 2. The ionic conductivity calculated from the electrolyte resistance is 5.2 mS/cm², which matches well with the previously measured value of 4.6 mS/cm² from the ionic conductivity test in FIG. 3A. The high ionic conductivity at elevated temperature, easy fabrication, and good chemical stability of the K₃OI system make it a promising candidate for molten K metal batteries. For instance, Na-β″-alumina solid electrolyte has enabled the development of molten sulfur (Na-S batteries) and ZEBRA batteries, which typically work at 300-350° C.

TABLE 2
The fitting results of the electrochemical impedance
spectra of K/K_{2.9}Ba_{0.05}OI/K symmetric cell at 270° C.

| Element | Value | Error | Error % |
|---|---|---|---|
| Rᵢ | 111.6 | 0.88 | 0.79 |
| CPE_{c}-T | 5.249E−5 | 1.898E−6 | 3.8 |
| CPE_{c}-P | 0.4233 | 0.00402 | 0.95 |
| R_{c} | 255.7 | 1.58 | 0.62 |

### Example 5

As shown in the examples above, K₃OI solid electrolyte has proved their unique advantage compared to organic liquid electrolytes. Its excellent stability with K enables a stable plating and striping of K metal even at 270° C. The low cost and easy fabrication also make it appealing in practical battery applications. However, there is still a need to improve the ionic conductivity of K₃OI below 250° C. (the solid-solid phase transition temperature).

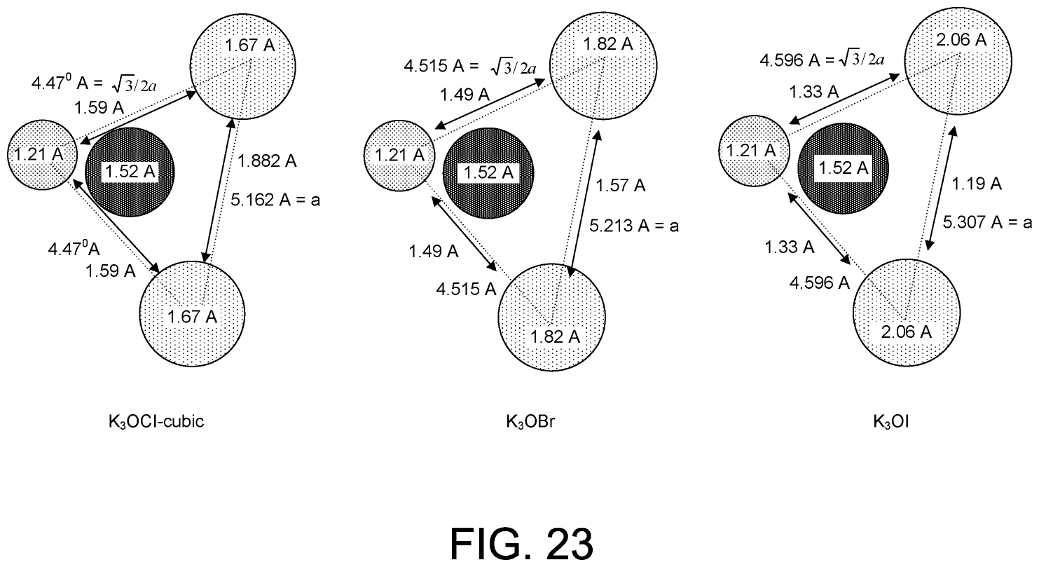

Iodide has the highest polarizability, which may indicate a trend of decrease. As shown in FIG. 23 and Table 3, the dimension of unit cells in K₃OX is determined by the K-O bond distance, and this does not change much (3% expansion from cubic-K₃OCl to K₃OI). Without wishing to be bound by any theory, therefore, it was assumed that the decrease of halide radius will leave more free volume that allows K⁺ ions to migrate. Based on this analysis, it was hypothesized that K₃OCl might possess the highest conductivity with the lowest activation energy.

TABLE 3
Lattice parameter and bottleneck length of K₃OCI
(high temperature cubic phase), K₃OBr, and K₃OI.

| | K₃OCI | K₃OBr | K₃OI |
|---|---|---|---|
| Halide Radius (Å) | 1.67 | 1.82 | 2.06 |
| Lattice Parameter (Å) | 5.16 | 5.21 | 5.31 |
| Bottleneck Length_ X (Å) | 1.59 | 1.49 | 1.33 |
| Bottleneck Length_X-X (Å) | 1.88 | 1.57 | 1.19 |

This example was conducted to test the hypothesis of whether a high ionic conductivity for K₃OX at milder temperatures (below 150° C.) can be achieved. The experimental results confirm that the structural tuning of K₃OX significantly increases the ionic conductivity. It was found that between K₃OCl, K₃OBr, and K₃OI, the highest conductivity is obtained in K₃OCl. Cation-doping is effective in expanding the unit cell volume and increasing the ionic conductivities. Still, further, it was shown that doping with additional metals, for example, and without limitations, with Rb can further improve ionic conductivity.

To form various compounds, the following materials and steps were used. Potassium nitrate (KNO₃) (99.0%, Sigma-Aldrich), potassium iodide (KI) (99.0%, Sigma-Aldrich), potassium bromide (KBr) (99.0%, Sigma-Aldrich), and potassium chloride (99.0%, Sigma-Aldrich) were dried under vacuum at 200° C.using chemical drier (Sigma-Aldrich) for 24 hours before use. Potassium (K) (98%, Alfa Aesar) was used directly. All the chemicals were stored in Ar filled glovebox.

Synthesis K₃OX (X=Cl, Br, I) can be synthesized via a two-step reaction. Pure K₂O was firstly made with 1.011 g KNO₃ (10 mmol) and 2.052 g K metal foil (51.0 mmol). 2% excess of K metal was used due to the evaporation of K during the synthesis. The mixture was placed on an alumina boat within a quartz tube under Ar flow. The sample was heated to 170° C. in 3 hours and kept at 170° C. for 12 hours. Then the sample was heated to 330° C. in 3 hours and kept at 170° C. for 12 hours. The synthesized K₂O (3.3 mmol) and corresponding KX (3.0 mmol) were weighted, ground for 10 mins, and pressed into a pellet. 10% excess of K₂O was used. The sample pellet was sealed in a silver tube at Ar atmosphere and heated to 420° C.in 2 hours, and kept at 420° C.for 18 hours. The sample was cooled naturally.

CThe phase purity of the powder sample was characterized using an X-ray diffractometer (Bruker D8 Advance, Cu Kα source, 40 kV, 40 mA). Differential scanning calorimetry (DSC) was used with an under dry N₂ flow. 5-10 mg samples for DSC measurements were sealed by using Al hermetic pans in an Ar-filled glove box. The cooling and heating rates were 5° C.min⁻¹. For the ionic conductivity test, the sample pellets were hot-pressed at 215° C.for 1 hour inside the glovebox. Pt was coated on both sides of the pellet by using a sputter coater to ensure sufficient electrical contact. Due to the air sensitivity of the sample, the AC impedance measurement was done with a homemade high-temperature electrochemical double sealing clamp cell using a Gamry Reference 600 potentiostat. An AC voltage with an amplitude of 50 mV was applied to the cell. The frequency range was from 1 MHz to 0.1 Hz. The temperature was controlled by a Thermo Scientific muffle furnace and was monitored by a digital thermocouple. The resulting data were fitted using the ZView software. The values of ionic conductivity were determined from the measured resistance by using the expression: σ=LARσ=LAR, where L is the thickness of the electrolyte, A is the area of electrolyte, and R is the resistance fitted from the Nyquist plot using the ZView software.

Bond valence site energy (E_{BVSE}) was analyzed using soft BV software. In this method, the bond valence site energy of the mobile ion (K-ion in this study) can be considered as a Morse-type interaction with the environmental anions and Coulomb repulsion of K-ion and other immobile cations. The Morse-type interaction can be separated into attractive interaction and short-range Born repulsion of K-ion and anions.

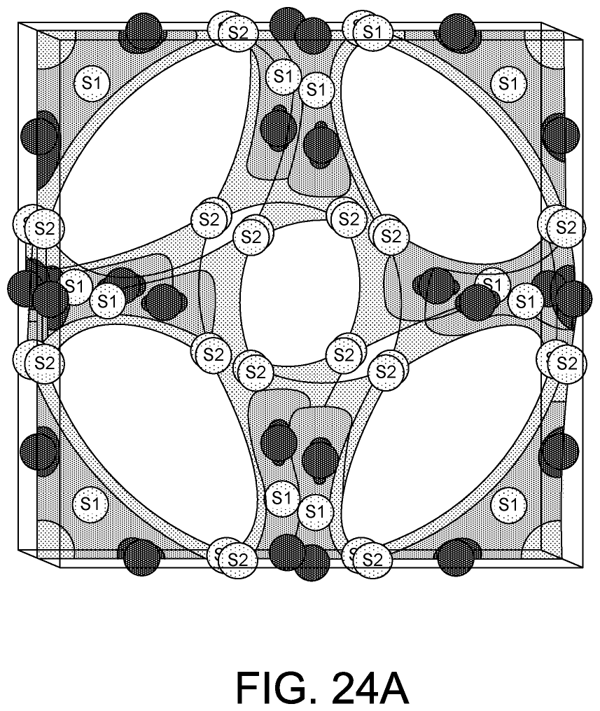

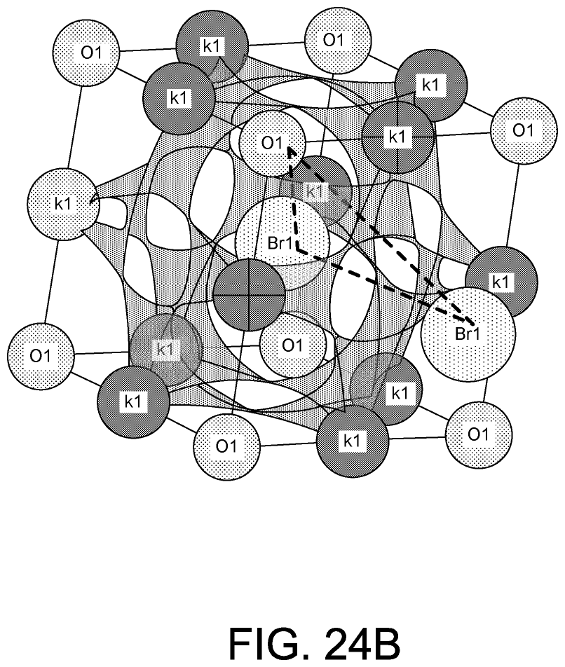

To predict how the halide affects the K-ion migration, bond valence site energy analysis was utilized to analyze the migration map and activation energy of K₃OX. The migration map of cubic phase K₃OX is shown in FIGS. 24A-24B. In FIG. 24A, the dark spheres represent the lowest energy point. The brown spheres represent the saddle point. It is worth noting that K-ions reported in actual crystal structures do not sit on the lowest energy point. It may be due to the Columbic repulsion between K-ions, which is ignored by the bond valence site energy ignores analysis. According to the calculated migration map, K-ion has an isotropic three-dimensional migration pathway. In FIG. 24B, the bottleneck for the two highlighted K-ion is shown. The K-ion needs to go through a triangle formed of one oxygen and two halogens to get to the near K sites.

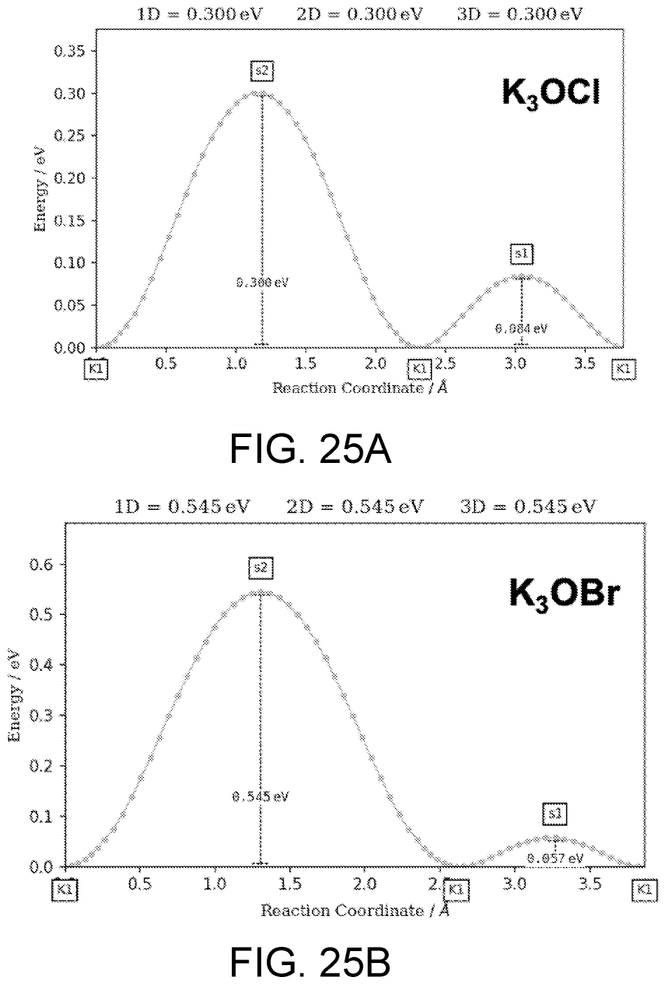

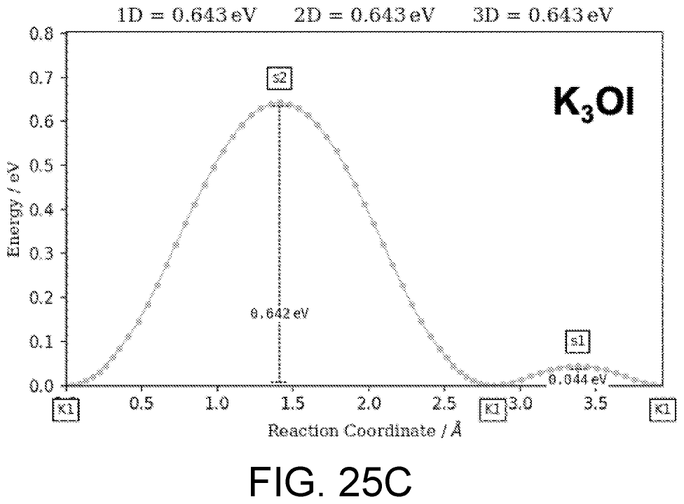

FIGS. 25A-25C compare the migration barriers along the reaction pathway for K-ion in K₃OX. K₃OCl (0.300 eV) shows a lower migration barrier compared with K₃OBr (0.545 eV) and K₃OI (0.642 eV). This result supports the initial hypothesis that K₃OCl might possess the highest conductivity with the lowest activation energy in K₃OX.

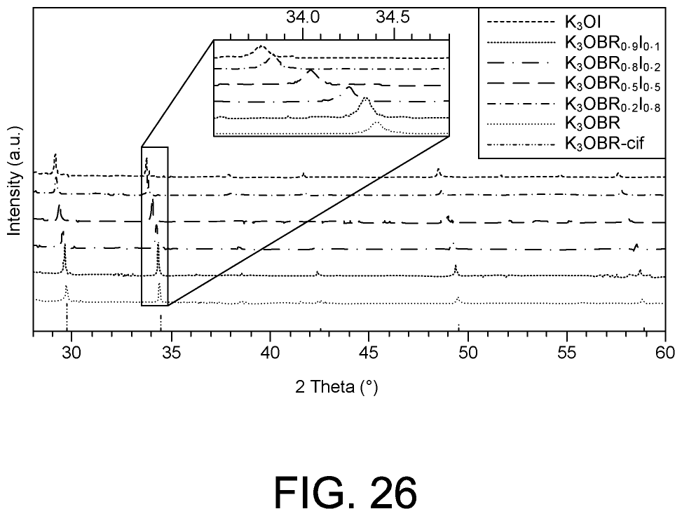

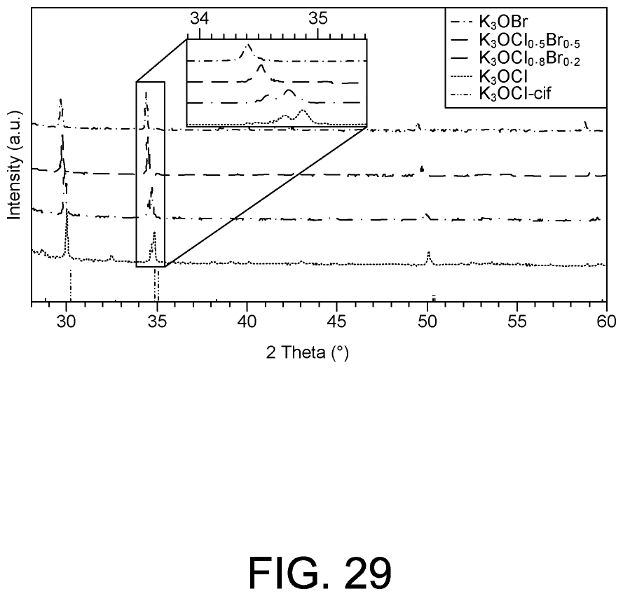

FIGS. 26 and FIG. 29 show the XRD results of the synthesized K₃OX (X=Cl, Br, I and their solid solutions). The results indicate K₃OX can form a solid solution at any ratio of halide, which proves the excellent structural tunability of anti-perovskite electrolytes.

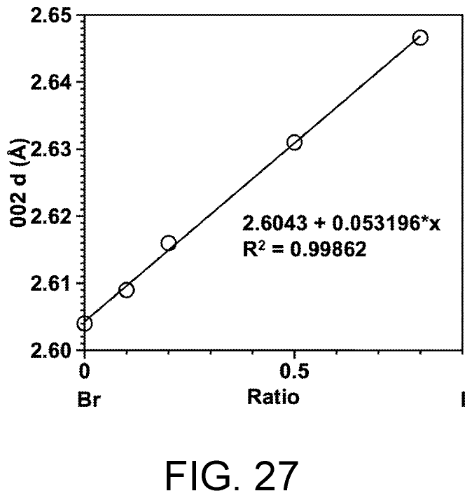

FIG. 27 shows the relation between the lattice parameter of the synthesized solid solution and the halide composition. The lattice parameter has a simple linear relation with the composition. It is worth noting that there is only 1.9% lattice expansion changing from K₃OBr to K₃OI.

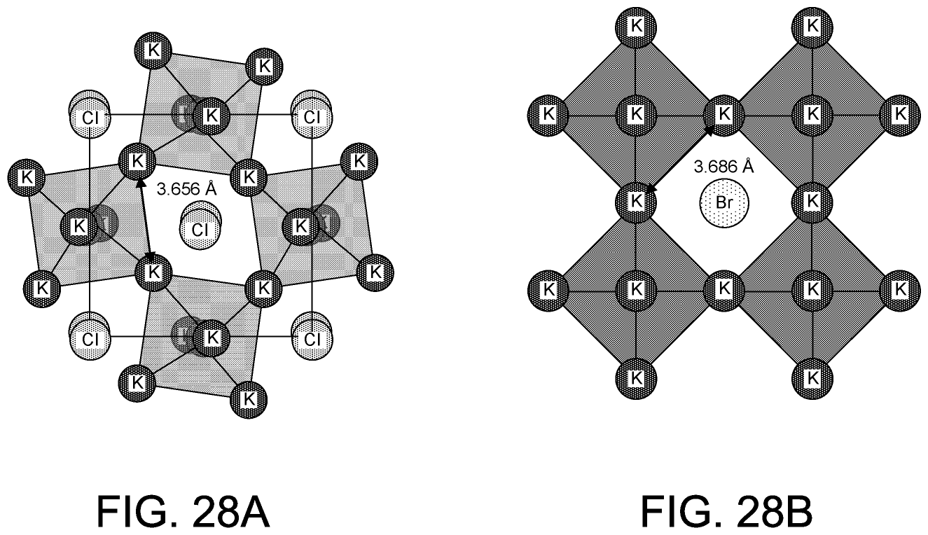

Different from K₃₀Br and K₃OI, as shown in FIG. 28A-28B, K₃OCl is an orthorhombic crystal structure at room temperature due to the OK_{6/2} octahedra tilting. FIG. 29 shows the XRD results of the solid solution of K₃OCl and K₃OBr. Interestingly, the room temperature crystal structure changes from orthorhombic to cubic with at least a 50% Br ratio.

Goldschmidt tolerance factor is commonly used to evaluate the structural stability of perovskites. For an ideal cubic perovskite, the tolerance factor should be 1. The tolerance factor of K₃OX is calculated based on the below equation:

t=rX+rK2−√(rO+rK)t=rX+rK2(rO+rK)

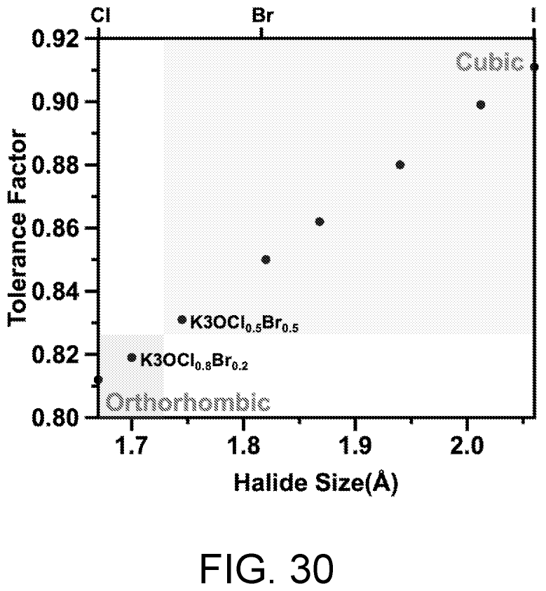

The halide size has a linear relation with the calculated tolerance factor. Moreover, when the tolerance factor is larger than 0.83 (K3OClo.5Bro.5), the structure is cubic at room temperature. When the tolerance factor is smaller than 0.82 (K₃OCl_{0.8}Br_{0.2}), the structure is orthorhombic at room temperature. Therefore, the cubic phase cutoff for anti-perovskite (0.83) is obviously smaller than perovskite (1). (FIG. 30)

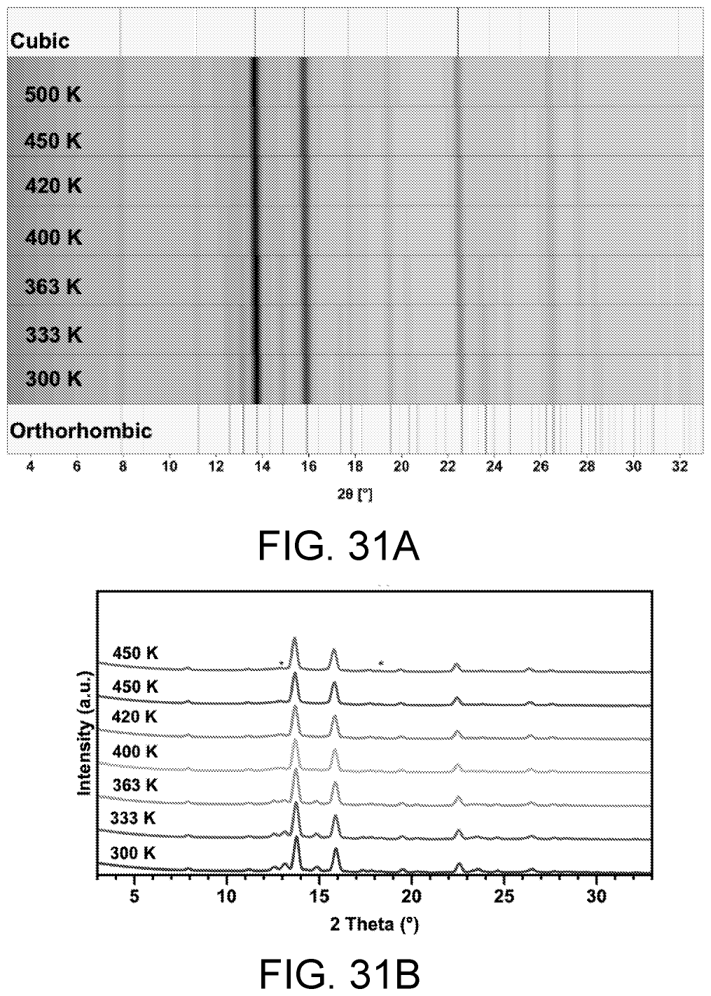

FIGS. 31A-31B show the temperature variable XRD results of K₃OCl from 300 to 500 K. The XRD pattern change clearly shows that K₃OCl changes from orthorhombic to cubic at approximately 400 K.

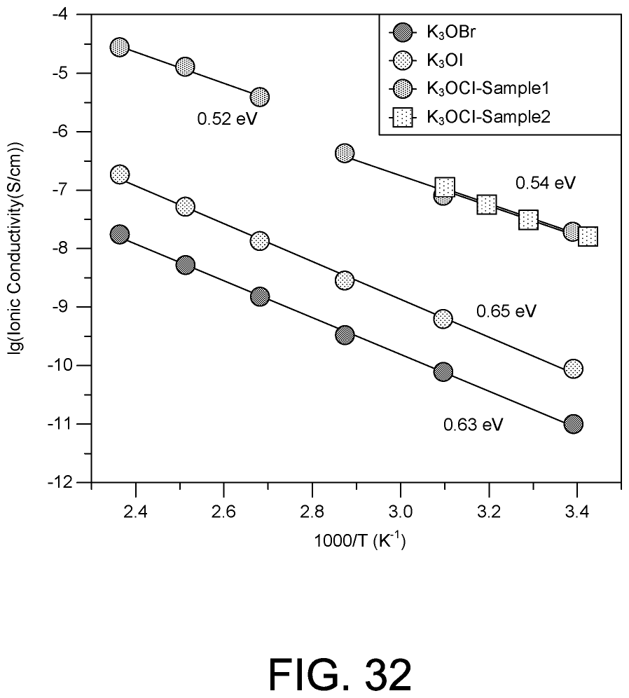

FIG. 32 compares the ionic conductivity of K₃OCl, K₃OBr, and K₃OI. Among them, K₃OBr shows the lowest ionic conductivity. Compared with K₃OBr, K₃OI shows one order of magnitude higher. It may be because the I ion is softer than the Br ion. Moreover, K₃OCl shows three to four orders of magnitude higher ionic conductivity compared K₃OBr. These results support the hypothesis of how the halide affects the K-ion migration and indicate free volume may play a more important role compared with polarizability.

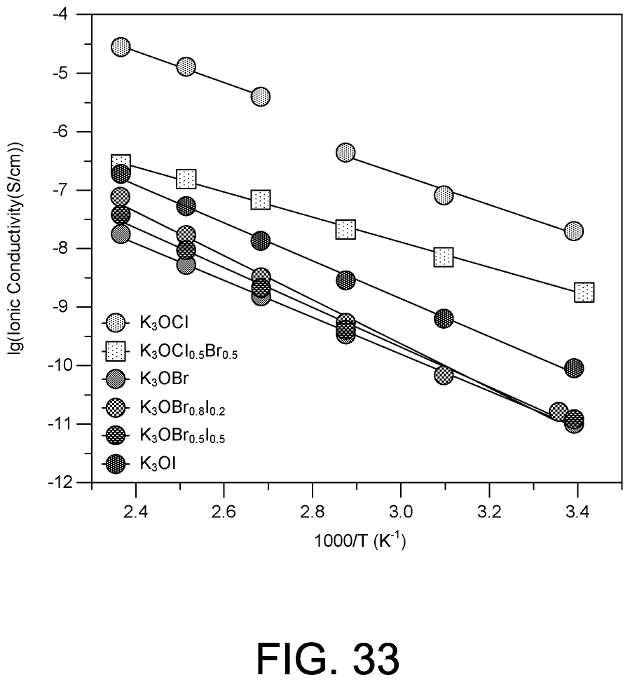

For the solid solution of K₃OCl and K₃OBr, the halide mixing phase K₃OCl_{0.5}Br_{0.5} shows an ionic conductivity in the middle of K₃OCl and K₃OBr (FIG. 33). For the solid solution of K₃OBr and K₃OI, the trend of ionic conductivity is K₃OI>K₃OBr_{0.8}I_{0.2}>K₃OBr_{0.5}I_{0.5}>K₃OBr. These results indicate the halide mixing phase is not superior to the single halide phase.

As shown in Table 3, since the lattice parameter is mainly determined by M-O bond, the lattice only expands by 3% from cubic-K₃OCl to K301. Since free volume has shown an obvious impact from the case of K₃OCl, replacing some K with Rb was proposed to increase the length of M-O to increase the free volume of the lattice.

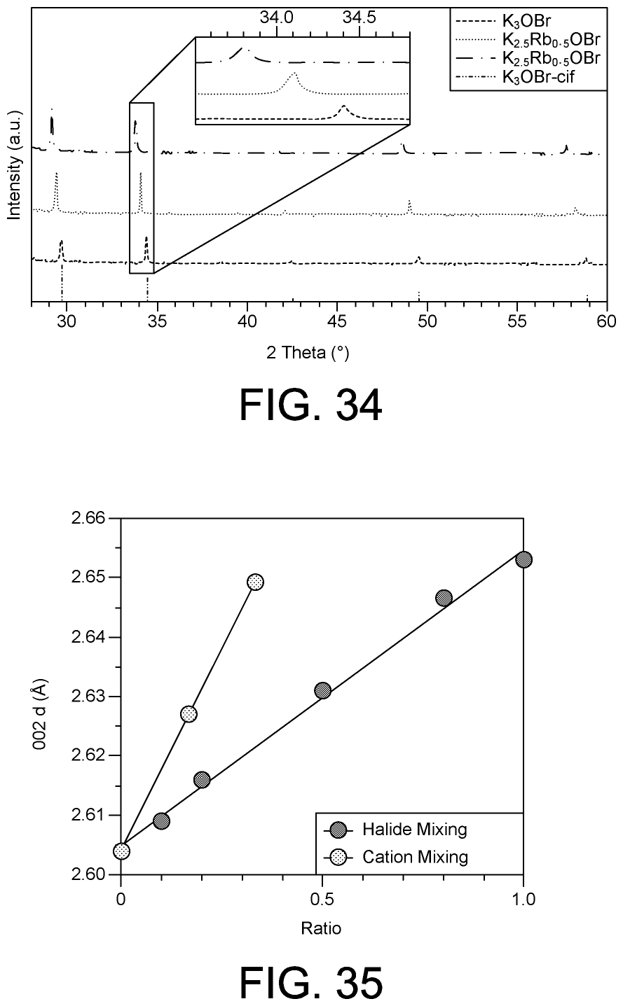

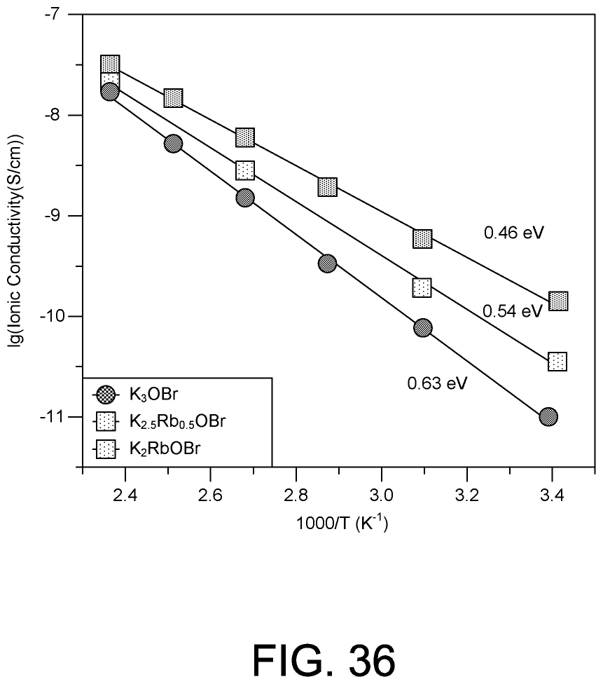

FIG. 35 compares the halide mixing and cation mixing on the influence of lattice parameters for K₃OBr based on the XRD results. Using I replace Br slightly increases the lattice parameter. However, the lattice expansion is still limited by the O-K bond length in OK6/2 octahedra. The observed lattice expansion by Rb mixing is more significant than halide mixing. As a result, the ionic conductivity has improved significantly by Rb mixing. As shown in FIG. 36, for the value of ionic conductivity, K₂RbOBr>K2.5Rb_{0.5}OBr>K₃OBr. Moreover, for the activation energy, K₂RbOBr<K_{2.5}Rb_{0.5}OBr<K₃OBr. Both trends indicate Rb mixing facilitates K-ion conduction. Those results confirm the hypothesis of enhancing K-ion migration by increasing M-O bond length. The XRD of a solid solution of K₃OBr and Rb₃OBr is shown in FIG. 34.

Although several aspects of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove and that many modifications and other embodiments are intended to be included within the scope of the appended claims. Moreover, although specific terms are employed herein, as well as in the claims which follow, they are used only in a generic and descriptive sense and not for the purposes of limiting the described invention or the claims which follow.

Unless defined otherwise, all technical and scientific terms used herein have the same meanings as commonly understood by one of skill in the art to which the disclosed invention belongs. Publications cited herein and the materials for which they are cited are specifically incorporated by reference.

The claims are not intended to include, and should not be interpreted to include, means-plus- or step-plus-function limitations unless such a limitation is explicitly recited in a given claim using the phrase(s) “means for” or “step for,” respectively.

### REFERENCES

(1) Xiao, N .; Ren, X.; McCulloch, W. D.; Gourdin, G.; Wu, Y. Potassium Superoxide: A Unique Alternative for Metal-Air Batteries. Acc. Chem. Res. 2018, 51 (9), 2335-2343. https://doi.org/10.1021/acs.accounts.8b00332.
(2) Kim, H.; Kim, J. C.; Bianchini, M.; Seo, D. H.; Rodriguez-Garcia, J.; Ceder, G. Recent Progress and Perspective in Electrode Materials for K-Ion Batteries. Advanced Energy Materials. John Wiley & Sons, Ltd March 1, 2018, p 1702384. https://doi.org/10.1002/aenm.201702384.
(3) Hwang, J. Y.; Myung, S. T.; Sun, Y. K. Recent Progress in Rechargeable Potassium Batteries. Advanced Functional Materials. John Wiley & Sons, Ltd October 1, 2018, p 1802938. https://doi.org/10.1002/adfm.201802938.
(4) Famprikis, T.; Canepa, P.; Dawson, J. A.; Islam, M. S.; Masquelier, C. Fundamentals of Inorganic Solid-State Electrolytes for Batteries. Nat. Mater. 2019, 18 (12), 1278-1291. https://doi.org/10.1038/s41563-019-0431-3.
(5) Qin, L.; Schkeryantz, L.; Zheng, J.; Xiao, N.; Wu, Y. Superoxide-Based K-O2Batteries: Highly Reversible Oxygen Redox Solves(1) Xiao, N.; Ren, X.; McCulloch, W. D.; Gourdin, G.; Wu, Y. Potassium Superoxide: A Unique Alternative for Metal-Air Batteries. Acc. Chem. Res. 2018, 51 (9), 2335-2343. https://doi.org/10.1021/acs.accounts.8b00332.
(2) Kim, H.; Kim, J. C.; Bianchini, M.; Seo, D. H.; Rodriguez-Garcia, J.; Ceder, G. Recent Progress and Perspective in Electrode Materials for K-Ion Batteries. Advanced Energy Materials. John Wiley & Sons, Ltd March 1, 2018, p 1702384. https://doi.org/10.1002/aenm.201702384.
(3) Hwang, J. Y.; Myung, S. T.; Sun, Y. K. Recent Progress in Rechargeable Potassium Batteries. Advanced Functional Materials. John Wiley & Sons, Ltd October 1, 2018, p 1802938. https://doi.org/10.1002/adfm.201802938.
(4) Famprikis, T.; Canepa, P.; Dawson, J. A.; Islam, M. S.; Masquelier, C. Fundamentals of Inorganic Solid-State Electrolytes for Batteries. Nat. Mater. 2019, 18 (12), 1278-1291. https://doi.org/10.1038/s41563-019-0431-3.
(5) Qin, L.; Schkeryantz, L.; Zheng, J; Xiao, N .; Wu, Y. Superoxide-Based K-O2Batteries: Highly Reversible Oxygen Redox Solves Challenges in Air Electrodes. J. Am. Chem. Soc. 2020, 142 (27), 11629-11640. https://doi.org/10.1021/jacs.0c05141.
(6) Eremin, R. A.; Kabanova, N. A.; Morkhova, Y. A.; Golov, A. A.; Blatov, V. A. High-Throughput Search for Potential Potassium lon Conductors: A Combination of Geometrical-Topological and Density Functional Theory Approaches. Solid State Ionics 2018, 326, 188-199. https://doi.org/10.1016/j.ssi.2018.10.009.
(7) Cong, G.; Wang, W.; Lai, N.-C.; Liang, Z.; Lu, Y.-C. A High-Rate and Long-Life Organic-Oxygen Battery. Nat. Mater. 2019. https://doi.org/10.1038/s41563-019-0286-7.
(8) Hueso, K. B.; Armand, M.; Rojo, T. High Temperature Sodium Batteries: Status, Challenges and Future Trends. Energy Environ. Sci. 2013, 6 (3), 734-749. https://doi.org/10.1039/c3ee24086j.
(9) Wang, Y.; Richards, W. D.; Ong, S. P.; Miara, L. J.; Kim, J. C.; Mo, Y.; Ceder, G. Design Principles for Solid-State Lithium Superionic Conductors. Nat. Mater. 2015, 14 (10), 1026-1031. https://doi.org/10.1038/nmat4369.
(10) Hull, S. Superionics: Crystal Structures and Conduction Processes. Reports Prog. Phys. 2004, 67 (7), 1233-1314. https://doi.org/10.1088/0034-4885/67/7/R05.
(11) Zhao, Y.; Daemen, L. L. Superionic Conductivity in Lithium-Rich Anti-Perovskites. Journal of the American Chemical Society. 2012, pp 15042-15047. https://doi.org/10.1021/ja305709z.
(12) Wang, Y.; Wang, Q.; Liu, Z.; Zhou, Z.; Li, S.; Zhu, J.; Zou, R.; Wang, Y.; Lin, J.; Zhao, Y. Structural Manipulation Approaches towards Enhanced Sodium Ionic Conductivity in Na-Rich Antiperovskites. J. Power Sources 2015, 293, 735-740. https://doi.org/10.1016/j.jpowsour.2015.06.002.
(13) Emly, A.; Kioupakis, E.; Van Der Ven, A. Phase Stability and Transport Mechanisms in Antiperovskite Li3OCl and Li3OBr Superionic Conductors. Chem. Mater. 2013, 25 (23), 4663-4670. https://doi.org/10.1021/cm4016222.
(14) Zhang, Y.; Zhao, Y.; Chen, C. Ab Initio Study of the Stabilities of and Mechanism of Superionic Transport in Lithium-Rich Antiperovskites. Physical Review B-Condensed Matter and Materials Physics. 2013. https://doi.org/10.1103/PhysRevB.87.134303.
(15) Mouta, R.; Melo, M. Á. B.; Diniz, E. M.; Paschoal, C. W. A. Concentration of Charge Carriers, Migration, and Stability in Li3OCl Solid Electrolytes. Chem. Mater. 2014, 26 (24), 7137-7144. https://doi.org/10.1021/cm503717e.
(16) Spannenberg, A.; Burlakov, V. V.; Rosenthal, U. Crystal Structure of K₃OI. Zeitschrift fur Krist.-New Cryst. Struct. 2001, 216 (4), 616-618. https://doi.org/10.5940/jcrsj.57.96.
(17) Sun, Y.; Wang, Y.; Liang, X.; Xia, Y.; Peng, L.; Jia, H.; Li, H.; Bai, L.; Feng, J.; Jiang, H.; et al. Rotational Cluster Anion Enabling Superionic Conductivity in Sodium-Rich Antiperovskite Na3 OBH 4. J. Am. Chem. Soc. 2019, 141 (14), 5640-5644. https://doi.org/10.1021/jacs.9b01746.
(18) Hanghofer, I.; Redhammer, G. J.; Rohde, S.; Hanzu, I.; Senyshyn, A.; Wilkening, H. M. R.; Rettenwander, D. Untangling the Structure and Dynamics of Lithium-Rich Anti-Perovskites Envisaged as Solid Electrolytes for Batteries. Chem. Mater. 2018, 30 (22), 8134-8144. https://doi.org/10.1021/acs.chemmater.8b02568.
(19) Li, S.; Zhu, J.; Wang, Y.; Howard, J. W.; Lü, X.; Li, Y.; Kumar, R. S.; Wang, L.; Daemen, L. L.; Zhao, Y. Reaction Mechanism Studies towards Effective Fabrication of Lithium-Rich Anti-Perovskites Li3OX (X =Cl, Br). Solid State Ionics 2016, 284, 14-19. https://doi.org/10.1016/j.ssi.2015.11.027.
(20) Redaktion, D. The Crystal Structures of A- and P-K3OCl. Zeitschrift fur Anorg. und Allg. Chemie 2006, 632 (12-13), 1917. https://doi.org/10.1002/zaac.200690020.
(21) O'Keeffe, M.; Hyde, B. G. The Solid Electrolyte Transition and Melting in Salts. Philos. Mag. 1976, 33 (2), 219-224. https://doi.org/10.1080/00318087608225770.
(22) Boyce, J. B.; Huberman, B. A. Superionic Conductors: Transitions, Structures, Dynamics. Phys. Rep. 1979, 51 (4), 189-265. https://doi.org/10.1016/0370-1573(79)90067-X.
(23) Tian, Y.; Zeng, G.; Rutt, A.; Shi, T.; Kim, H.; Wang, J.; Koettgen, J.; Sun, Y.; Ouyang, B.; Chen, T; et al. Promises and Challenges of Next-Generation “Beyond Li-lon” Batteries for Electric Vehicles and Grid Decarbonization. https://doi.org/10.1021/acs.chemrev.0c00767.
(24) Fang, H.; Wang, S; Liu, J .; Sun, Q.; Jena, P. Superhalogen-Based Lithium Superionic Conductors. J. Mater. Chem. A 2017, 5 (26), 13373-13381. https://doi.org/10.1039/c7ta01648d.
(25) Fang, H.; Jena, P. Sodium Superionic Conductors Based on Clusters. ACS Appl. Mater. Interfaces 2019, 11 (1), 963-972. https://doi.org/10.1021/acsami.8b19003.
(26) Kresse, G.; Furthmüller, J. Efficiency of Ab-Initio Total Energy Calculations for Metals and Semiconductors Using a Plane-Wave Basis Set. Comput. Mater. Sci. 1996, 6 (1), 15-50. https://doi.org/10.1016/0927-0256(96)00008-0.
(27) Vargas-Hernández, R. A. Bayesian Optimization for Calibrating and Selecting Hybrid-Density Functional Models. J. Phys. Chem. A 2020, 124 (20), 4053-4061. https://doi.org/10.1021/acs.ipca. 0c01375.
(28) Perdew, J. P., Burke, K .; Ernzerhof, M. Generalized Gradient Approximation Made Simple. Phys. Rev. Lett. 1996, 77(18), 3865-3858.
(29) Higgins, R. A. Simple Method to Determine Electronic and lonic Components of the Conductivity in Mixed Conductors a Review. Ionics (Kiel). 2002, 8 (34), 300-313.
(30) Jain, A.; Ong, S.P.; Hautier, G.; Chen, W.; Richards, W.D.; Dacek, S.; Cholia, S.; Gunter, D.; Skinner, D.; Ceder, G.; et al. Commentary: The Materials Project: A Materials Genome Approach to Accelerating Materials Innovation. APL Materials. American Institute of Physcis Inc. July 2013.
(31) Tang, H.; Deng, Z.; Lin, Z.; Wang, Z.; Chu, I.-H.; Chen, C.; Zhu, Z.; Zheng, C.; Ong, S. P. Probing Solid-Solid Interfacial Reactions in All-Solid-State Sodium-Ion Batteries with First-Principles Calculations. Chem. Mater., 2017, 30(1), 163-173.
(32) Simoes, M. C.; Hughes, K. J.; Ingham, D. B.; Ma, L.; Pourkashanian, M. Estimation of the Thermochemical Radii and lonic Volumes of Complex Ions. Inorg. Chem. 2017, 56 (13), 7566-7573. https://doi.org/10.1021/acs.inorgchem.7b01205.
(33) Hosaka, T.; Kubota, K.; Hameed, A. S.; Komaba, S. Research Development on K-Ion Batteries. Chem. Rev. 2020, acs.chemrev.9b00463. https://doi.org/10.1021/acs.chemrey.9b00463.
(34) Yung-Fang Yu Yao; Kummer, J. T. Ion Exchange Properties of and Rates of Ionic Diffusion in Beta-Alumina. J. Inorg. Nucl. Chem. 1967, 29 (9). https://doi org/10.1016/0022-1902(67)80301-4.
(35) Baclig, A. C.; McConohy, G.; Poletayev, A.; Michelson, A.; Kong, N.; Lee, J. H.; Chueh, W. C.; Rugolo, J. High-Voltage, Room-Temperature Liquid Metal Flow Battery Enabled by Na-K|K-B″-Alumina Stability. Joule 2018, 2 (7), 1287-1296. https://doi. org/10. 1016/ joule 2018.04.008.
(36) Yuan, H.; Li, H.; Zhang, T.; Li, G.; He, T.; Du, F.; Feng, S. A K2Fe4O7 Superionic Conductor for All-Solid-State Potassium Metal Batteries. J. Mater. Chem. A 2018, 6 (18), 8413-8418. https://doi.org/10.1039/c8ta01418c
(37) Haffner, A.; Hatz, A.; Zeman, O. E. O.; Hoch, C.; Lotsch, B. V.; Johrendt, D. Polymorphism and Fast Potassium-Ion Conduction in the T5 Supertetrahedral Phosphidosilicate KSi 2 P 3. Angew. Chemie Int. Ed. 2021, 60 (24), 13641-13646. https://doi.org/10.1002/anie.202101187.
(38) Sheppard, D.; Xiao, P.; Chemelewski, W.; Johnson, D. D.; Henkelman, G. A Generalized Solid-State Nudged Elastic Band Method. J. Chem. Phys. 2012, 136 (7), 74103. https://doi.org/10.1063/1.3684549.
(39) Krauskopf, T.; Hartmann, H.; Zeier, W. G.; Janek, J. Toward a Fundamental Understanding of the Lithium Metal Anode in Solid-State Batteries—An Electrochemo-Mechanical Study on the Garnet-Type Solid Electrolyte Li 6.25 Al 0.25 La 3 Zr 2 0 12. ACS Appl. Mater. Interfaces 2019, 11 (15), 14463-14477. https://doi.org/10.1021/acsami.9b02537.

1. A solid-state electrolyte comprising a compound having a formula:
A₍₃₋ₓ₎M_{y}B_{w}C_{z},
wherein:
x is from 0 to 1;
y is x, or x/2 or x/3;
w is from 0 to 1;
z is from 0 to 1, and wherein
A is a metal cation comprising Na⁺, Li⁺, K⁺, Cs⁺ or Rb⁺;
M is a monovalent, a divalent or a trivalent metal cation;
B comprises O²⁻ or S²⁻; and
C is one or more anions comprising F⁻, Cl⁻, Br⁻, I⁻, CN⁻, BH₄⁻, SO₄²⁻, NO₂⁻ or a combination thereof.

2. The solid-state electrolyte of claim 1, wherein
A is K⁺ and B is O²⁻

3. The solid-state electrolyte of claim 1, wherein M comprises at least one of Rb⁺, Mg⁺², Ca⁺², Pb⁺², Sb⁺², Bi⁺³, Sr⁺², Al³⁺ or NH⁴⁺

4. The solid-state electrolyte of claim 1, wherein C is selected from a group consisting of F⁻, Cl⁻, Br⁻, and I⁻, or a combination thereof.

5. The solid-state electrolyte of claim 2, wherein the compound has a formula of K₍₃₋ₓ₎M_{y}OI, K₍₃₋ₓ₎M_{y}OCl, K₍₃₋ₓ₎M_{y}OBr, K₍₃₋ₓ₎M_{y}OClₐBr_{b} or K₍₃₋ₓ₎M_{y}OBrₐI_{b} or K₍₃₋ₓ₎M_{y}OClₐI_{b}, wherein a is greater than 0 to less than 1, wherein b is greater than 0 to less than 1, and wherein a+b is 1.

6. The solid-state electrolyte of claim 1, wherein the compound has a crystalline structure up to 350° C.

7. The solid-state electrolyte of claim 1, wherein the compound exhibits a solid-solid phase transition at about 240° C.

8. The solid-state electrolyte of claim 1, wherein x is greater than 0.

9. The solid-state electrolyte of claim 8, wherein M is Ba⁺² or Rb⁺².

10. (canceled)

11. The solid-state electrolyte of claim 1, wherein the compound has an anti-perovskite structure.

12. The solid-state electrolyte of claim 5, wherein the compound has a cubic symmetry at room temperature.

13. The solid state-electrolyte of claim 9, wherein an ionic conductivity of the compound is at least one order of magnitude is higher than an ionic conductivity of a compound A₍₃₋ₓ₎M_{y}B_{w}C_{z} having substantially identical A, B, and C with x=0.

14. The solid state-electrolyte of claim 13, wherein the compound exhibits an ionic conductivity above about 3 mS/cm² as measured at a temperature above 240° C.

15. The solid state-electrolyte of claim 1, wherein the compound exhibits substantial reduction stability towards a metal anode, wherein the metal anode comprises a metal of A.

16. The solid-state electrolyte of claim 1, wherein the solid-state electrolyte is provided as a pellet, a film, a powder, or a combination thereof.

17. (canceled)

18. A battery comprising:
an anode;
a cathode; and
the solid-state electrolyte of claim 1.

19. The battery of claim 18, wherein the battery is a primary battery or a secondary battery.

20. (canceled)

21. The battery of claim 18, wherein the anode is a potassium metal anode.

22. A method comprising
reacting a metal A with
i) a salt comprising a cation A and a B; and
ii) a salt comprising the cation A and an anion C;
at a temperature effective to form a compound having a formula A₃B_{w}C_{z},
wherein:
w is from 0 to 1;
z is from 0 to 1;
A is a metal cation comprising Na⁺, Li⁺, K⁺, Cs⁺ or Rb⁺;
B comprises O²⁻ or S²⁻; and
C comprises F⁻, Cl⁻, Br⁻, I⁻, CN⁻, BH₄⁻, SO₄²⁻, NO₂⁻ or a combination thereof.

23. The method of claim 22 further comprising doping of the compound A₃B_{w}C_{z} to form a compound of a formula A₍₃₋ₓ₎M_{y}B_{w}C_{z}, wherein:
x is greater than 0 to 1;
y is x, or x/2 or x/3; and wherein
M is a monovalent, a divalent or a trivalent metal cation.

24. The method of claim 23, wherein M comprises at least one of Rb⁺, Mg⁺², Ca⁺², Pb⁺², Sb⁺², Bi⁺³, Sr⁺², Al⁺³ or NH₄⁺.
